(19) United States
(12) Patent Application Publication
(10) Pub. No.: US 2014/0237380 A1
(43) Pub. Date: Aug. 21, 2014

(54) Online shared calendar application that facilitates communication and coordination of shared events amongst users and their contacts

(71) Applicants: Kevin Kurrus, Islip Terrace, NY (US); Scott N. Weber, Smithtown, NY (US)

(72) Inventors: Kevin Kurrus, Islip Terrace, NY (US); Scott N. Weber, Smithtown, NY (US)

(21) Appl. No.: 13/770,795

(22) Filed: Feb. 19, 2013

(51) Int. Cl. H04L 29/06

(52) U.S. Cl. CPC H04L 65/403
USPC 715/752; 715/751

(57) ABSTRACT

An online shared calendar application which facilitates communication, coordination and scheduling for users to plan get-togethers and share event information with others. Users have their own personal calendars and can upload and/or manually enter their contacts' information, create and share events, and invite or inform individuals from their contacts to their events. Inviting/sharing events automatically e-mails these contacts and updates their calendars with the event. Contacts who were invited/informed respond from their calendars. These responses send immediate and automated e-mails to the inviter and update the inviter's calendar. Thus, this is an online, shared calendar application that facilitates the sharing and coordination of events among users' contacts.

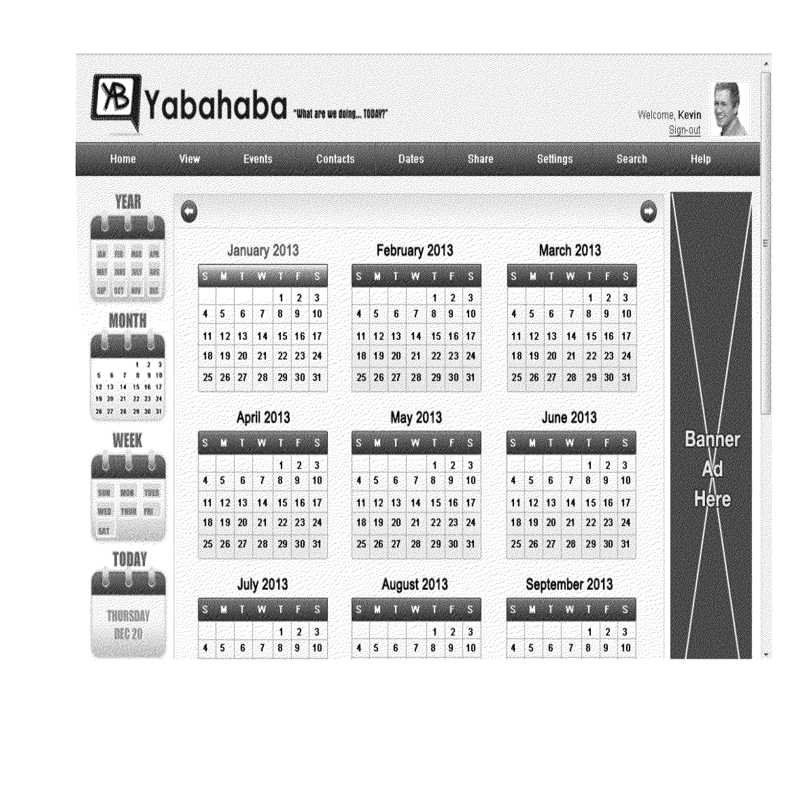

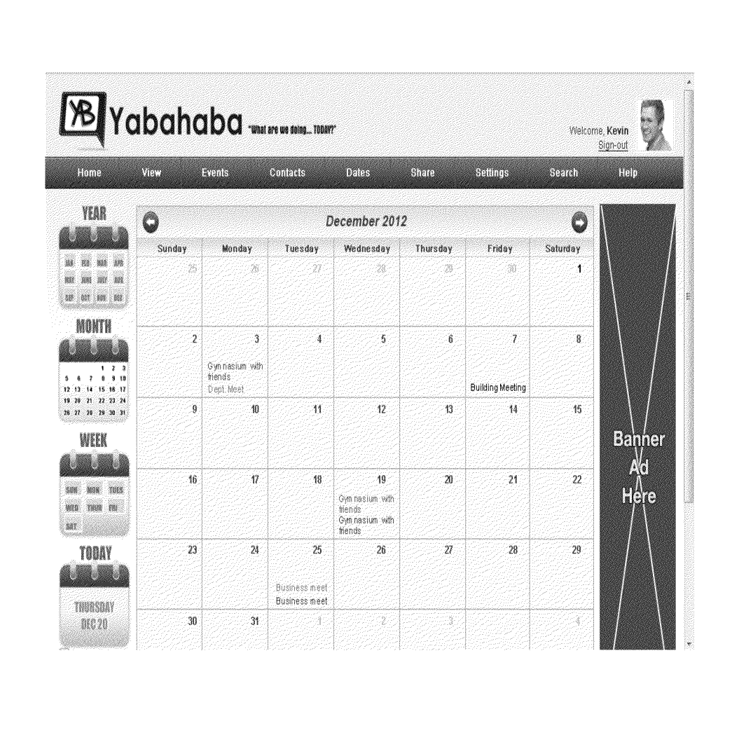

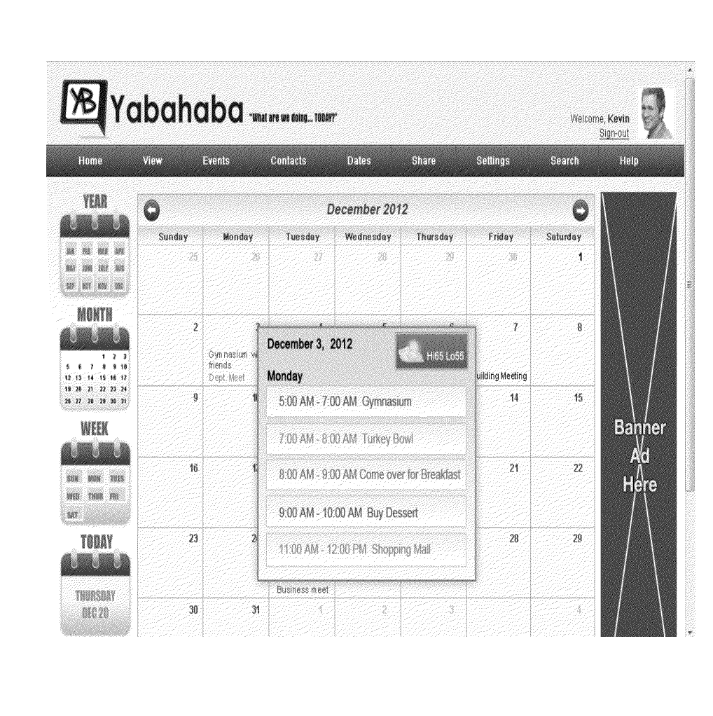

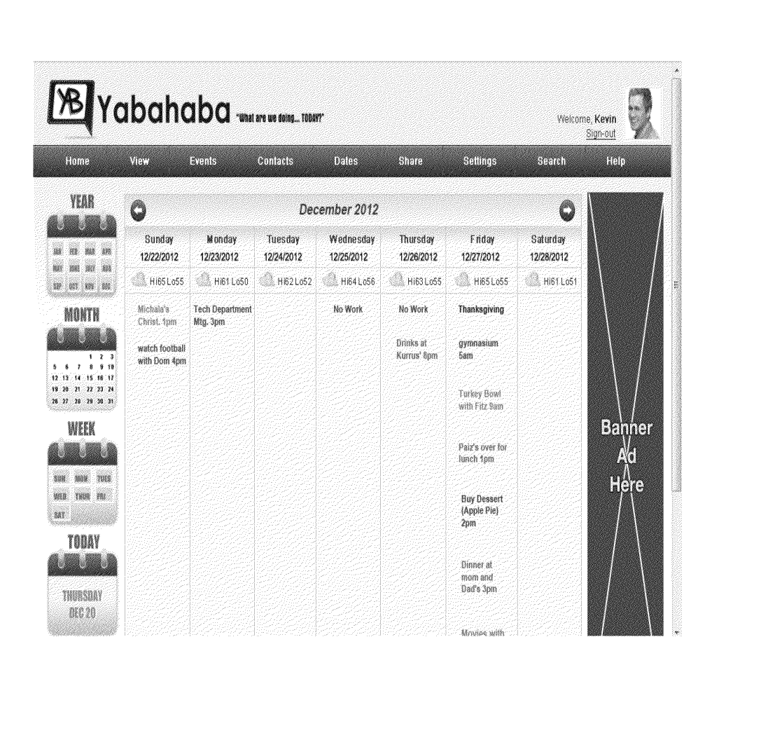

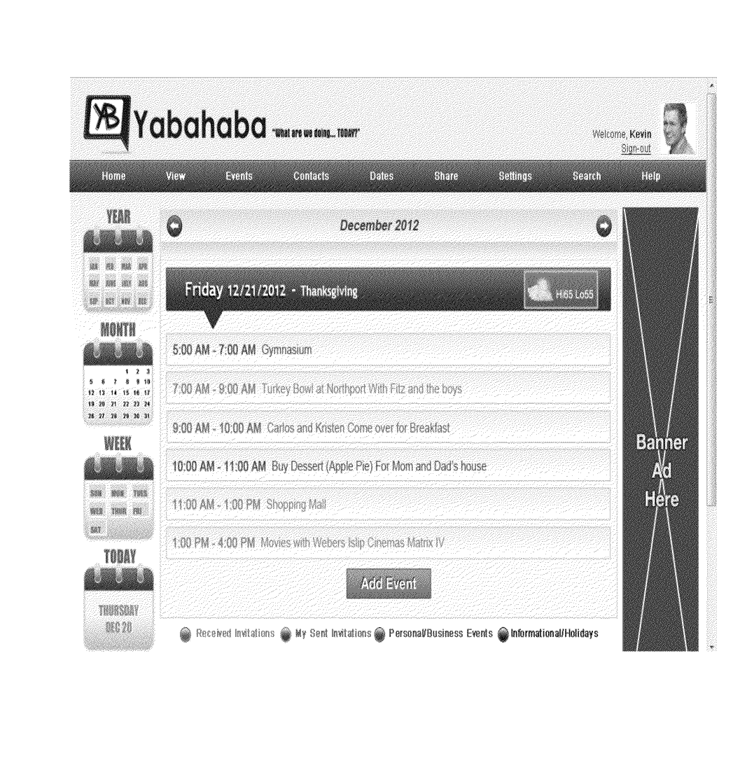

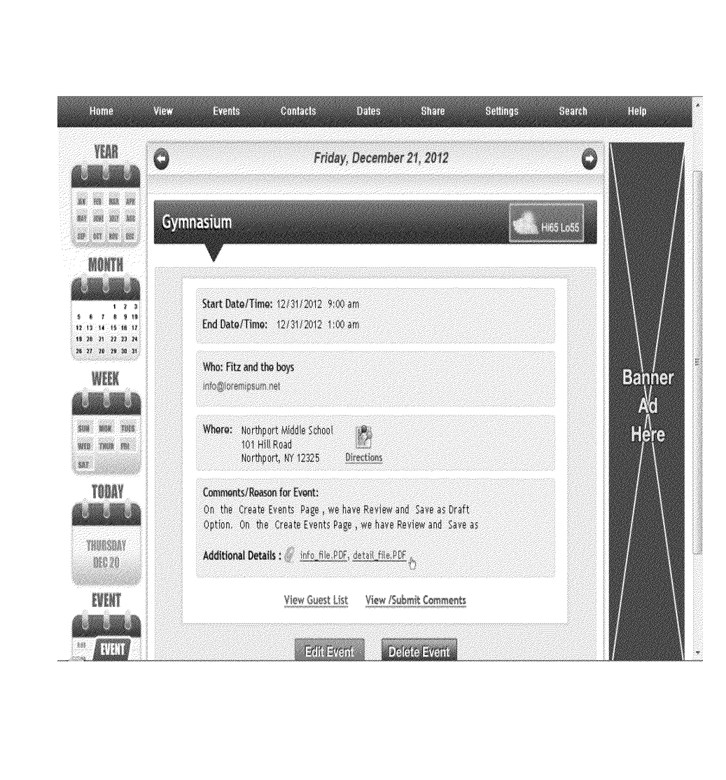

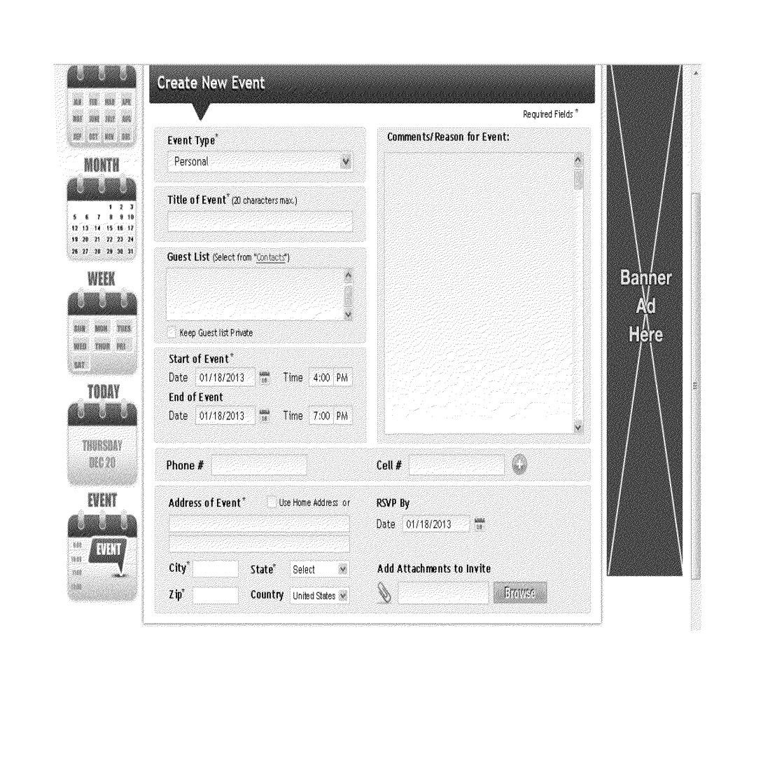

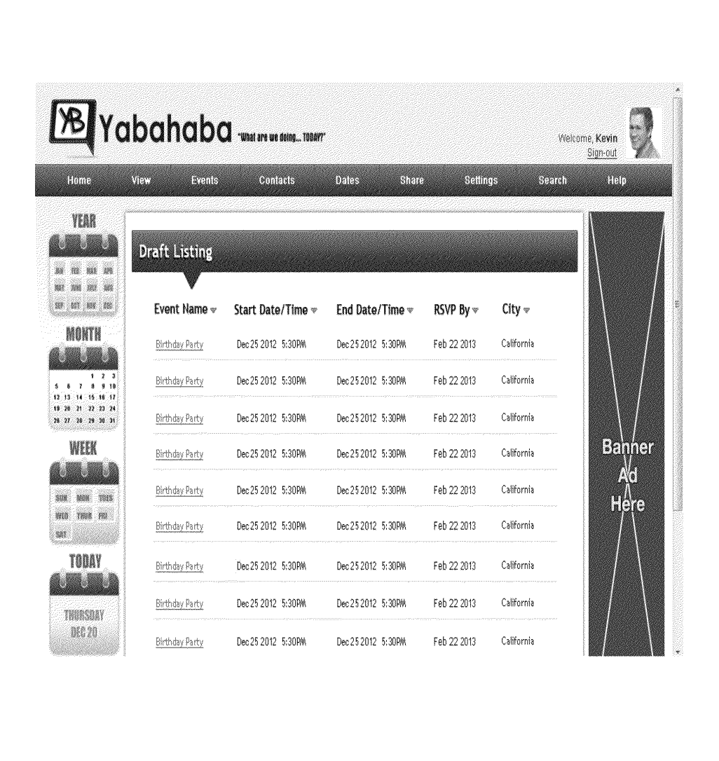

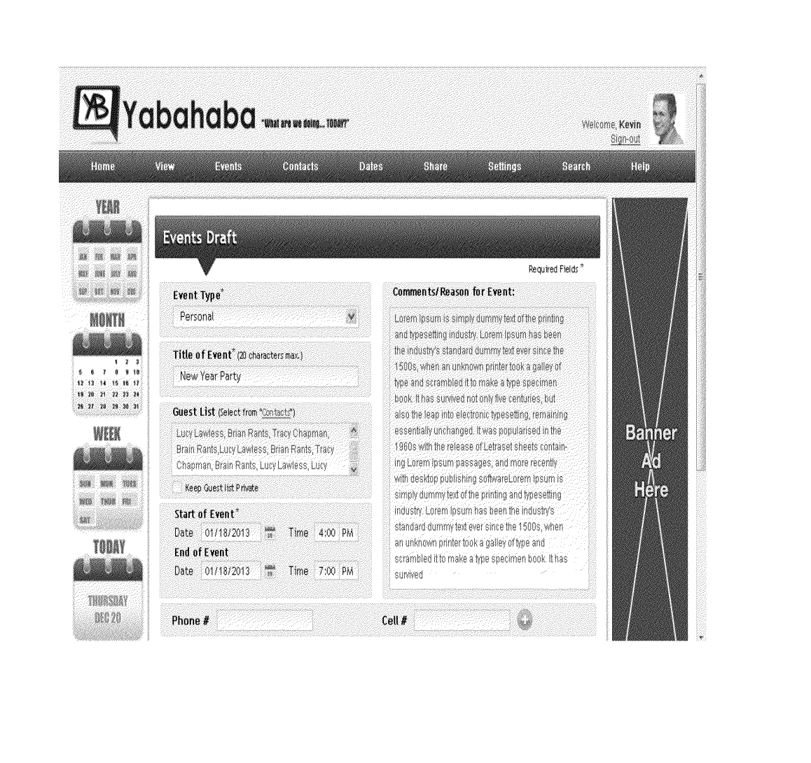

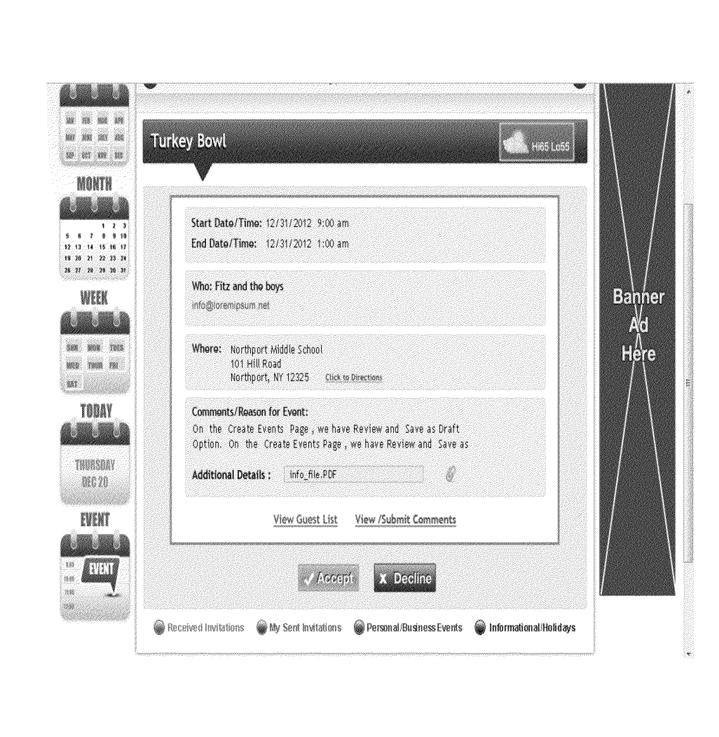

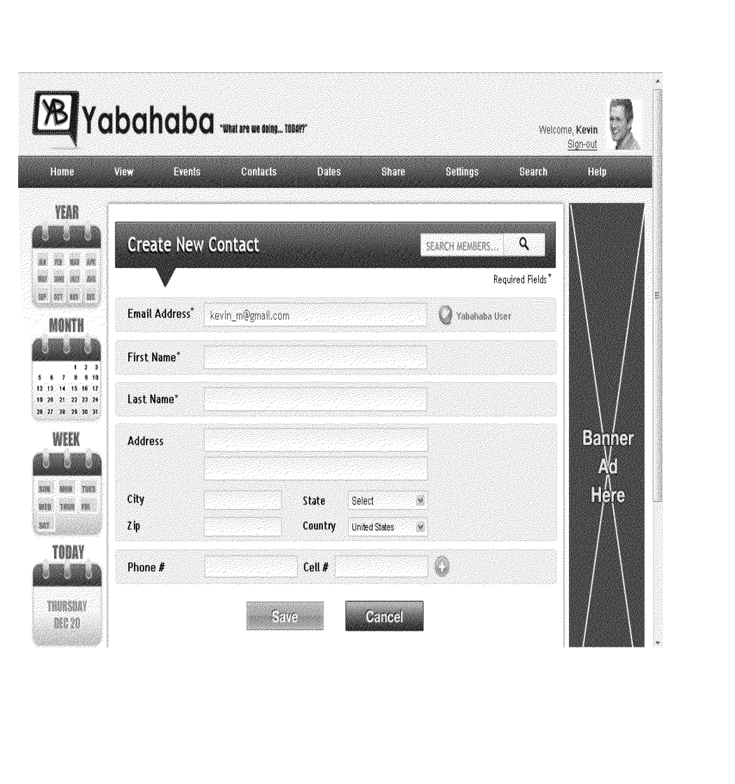

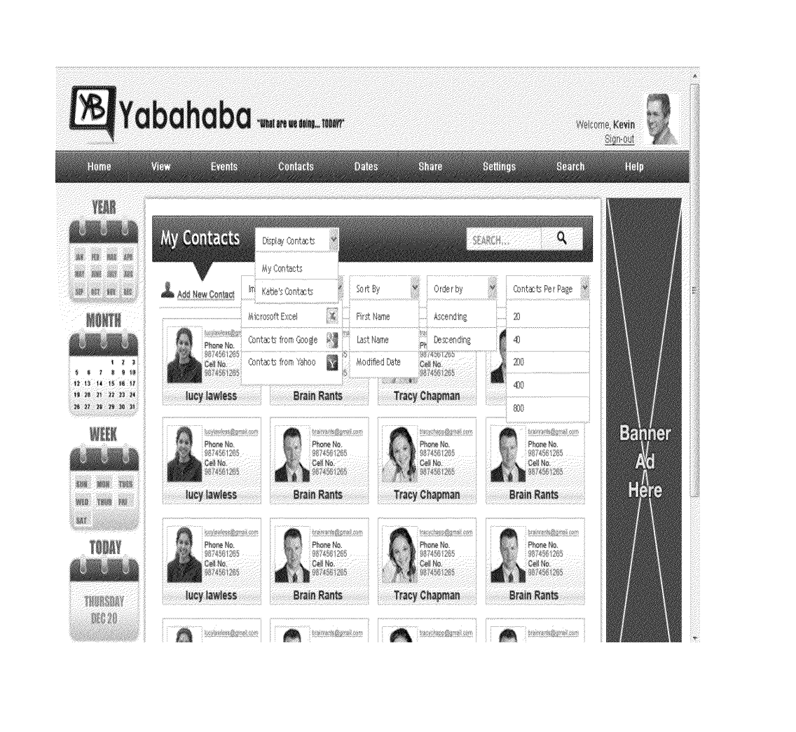

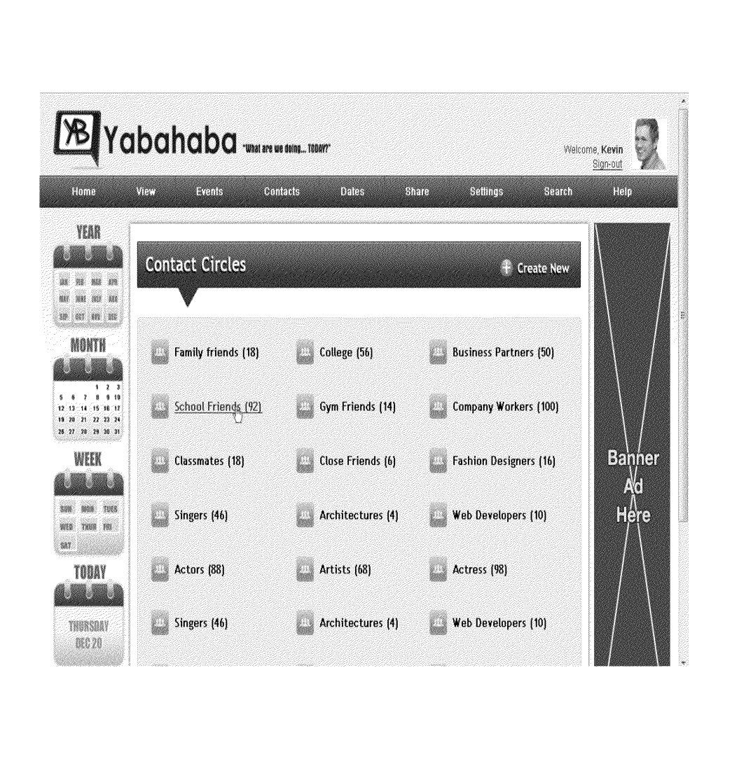

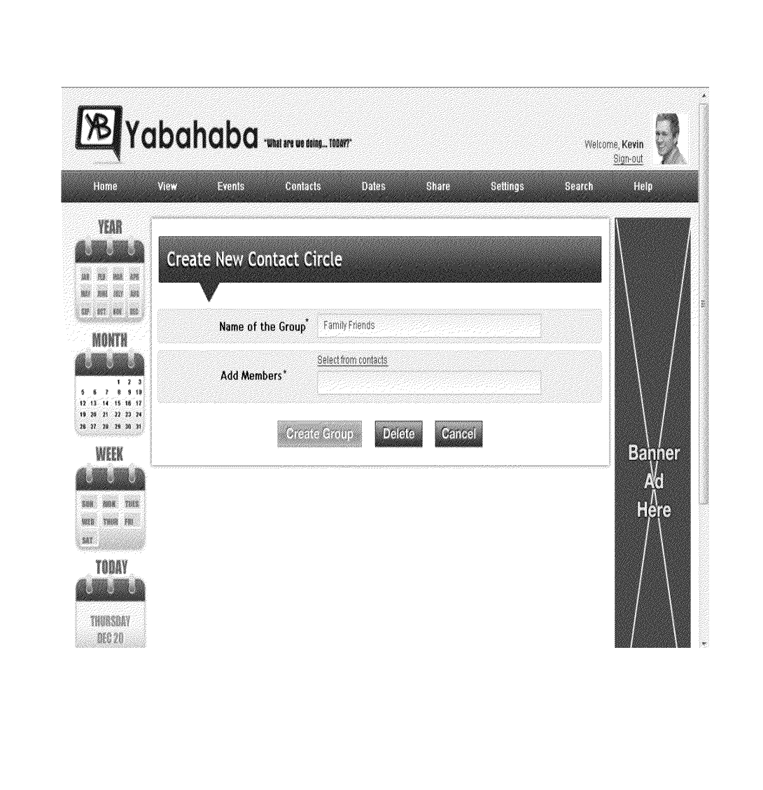

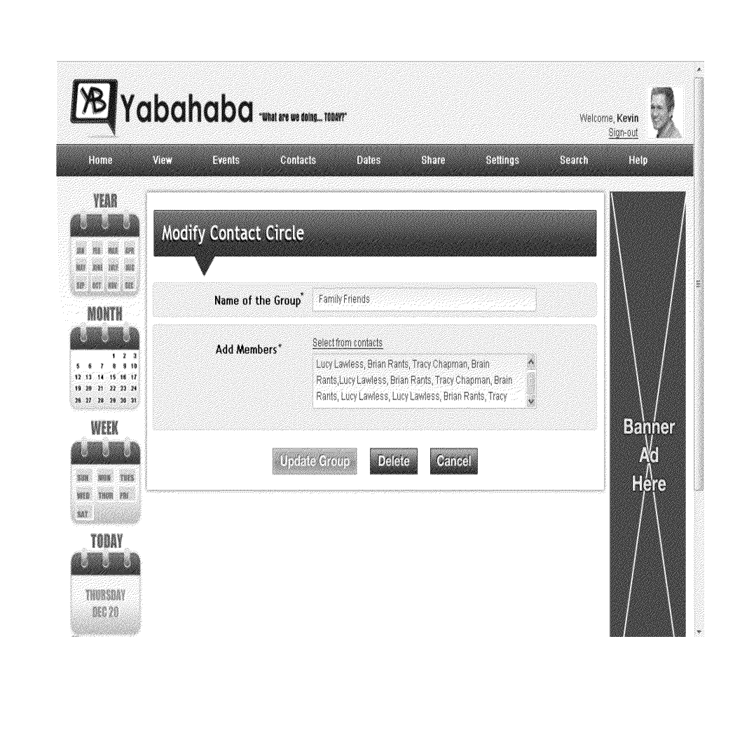

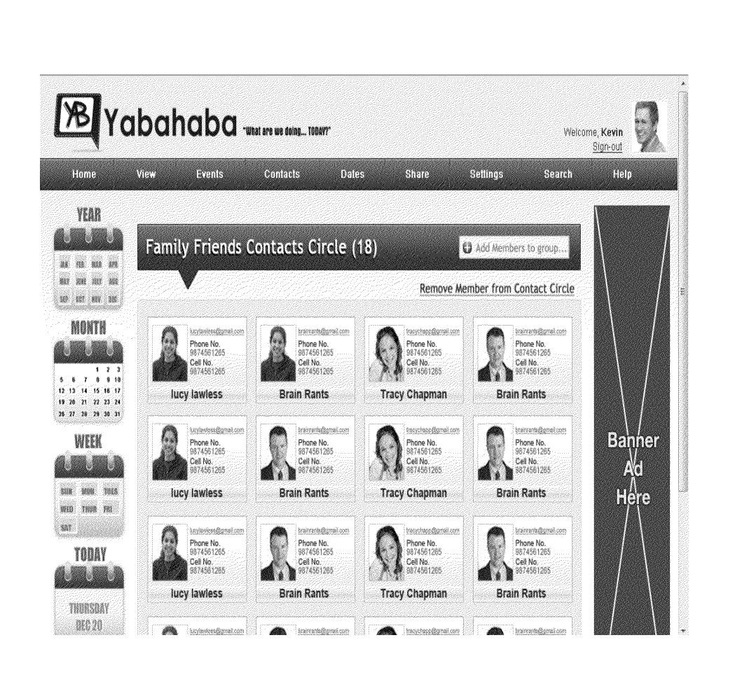

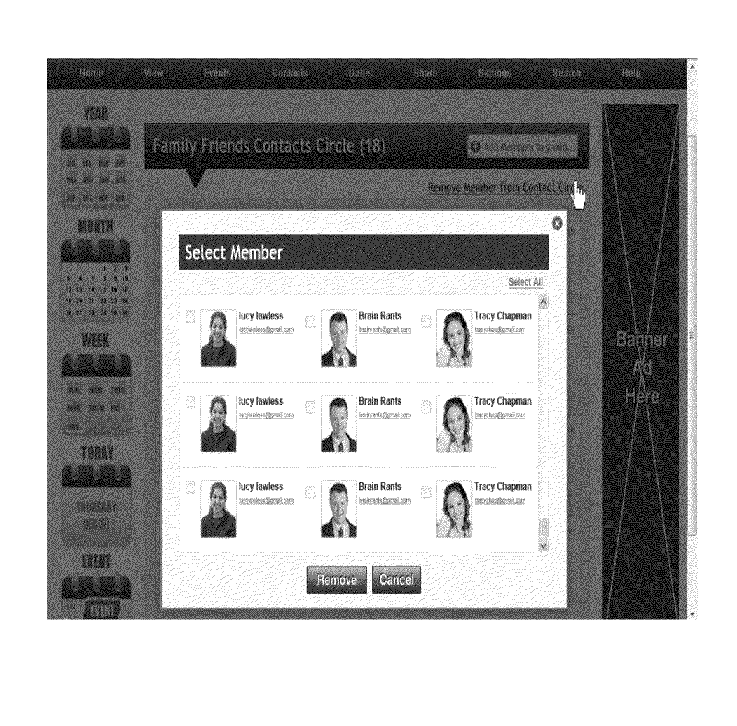

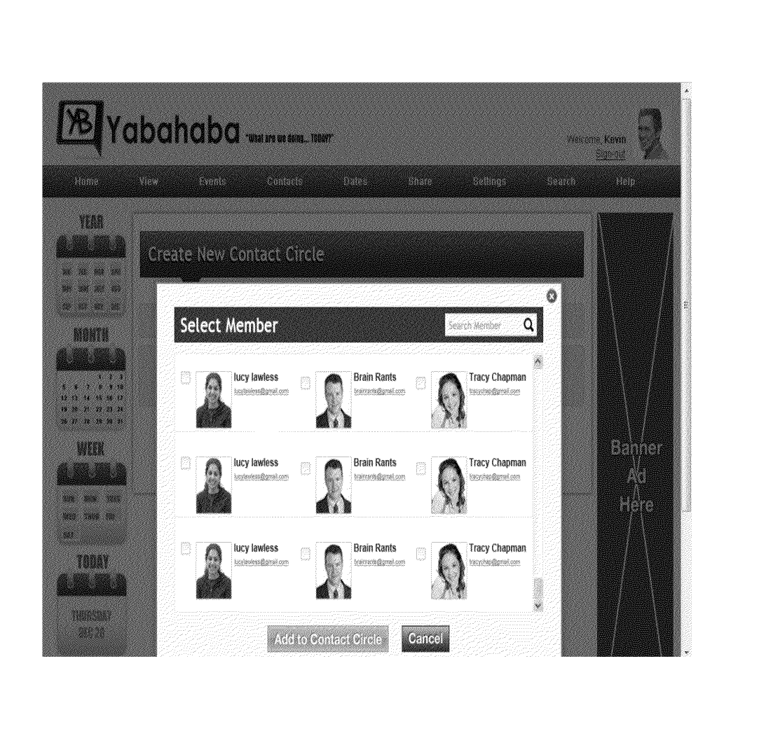

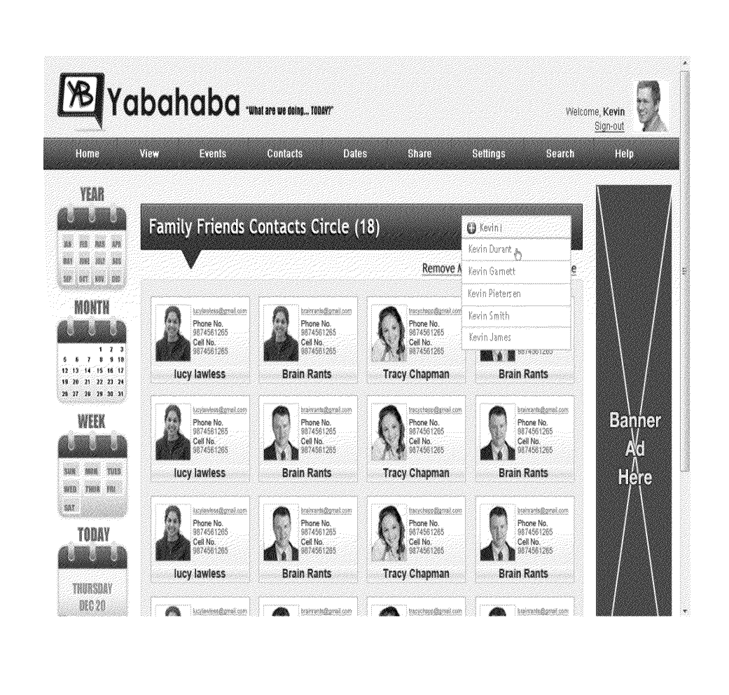

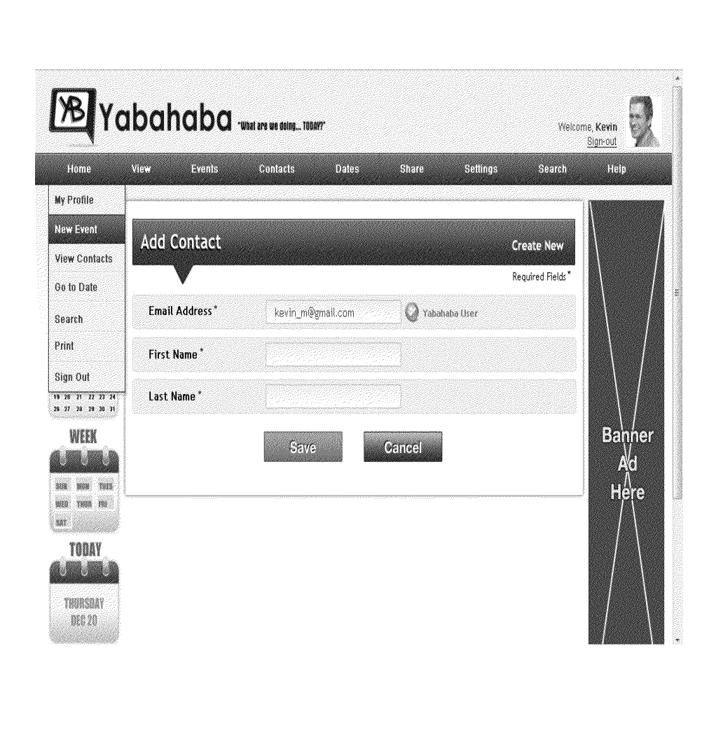

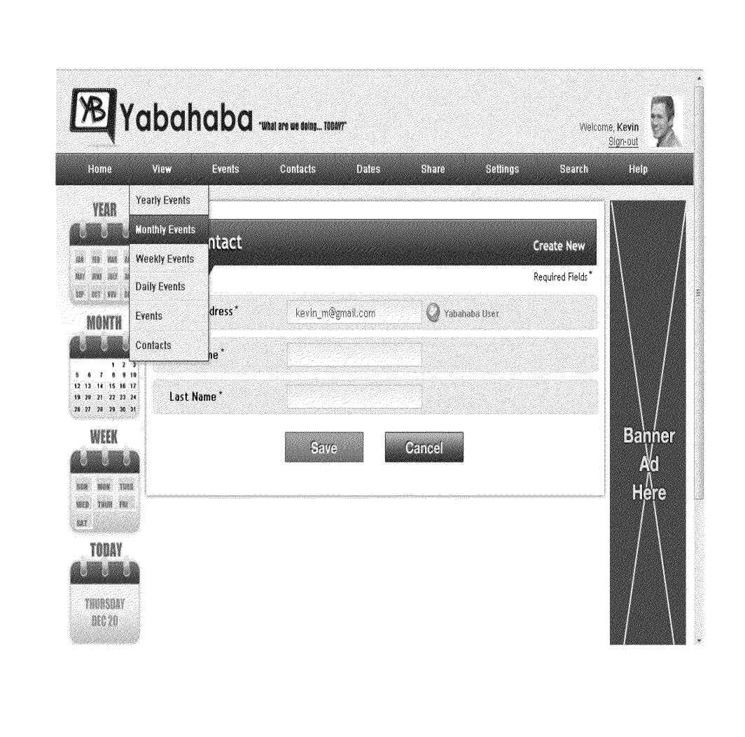

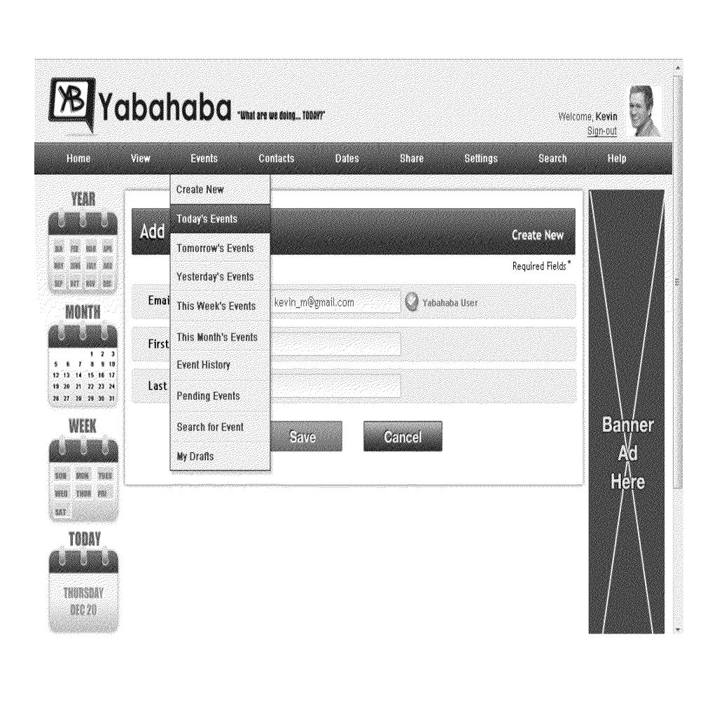

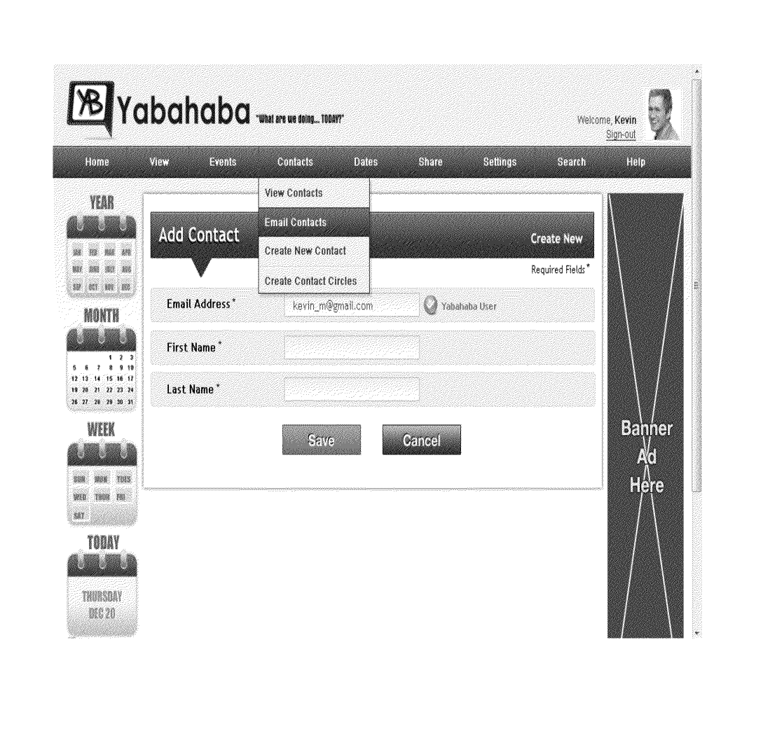

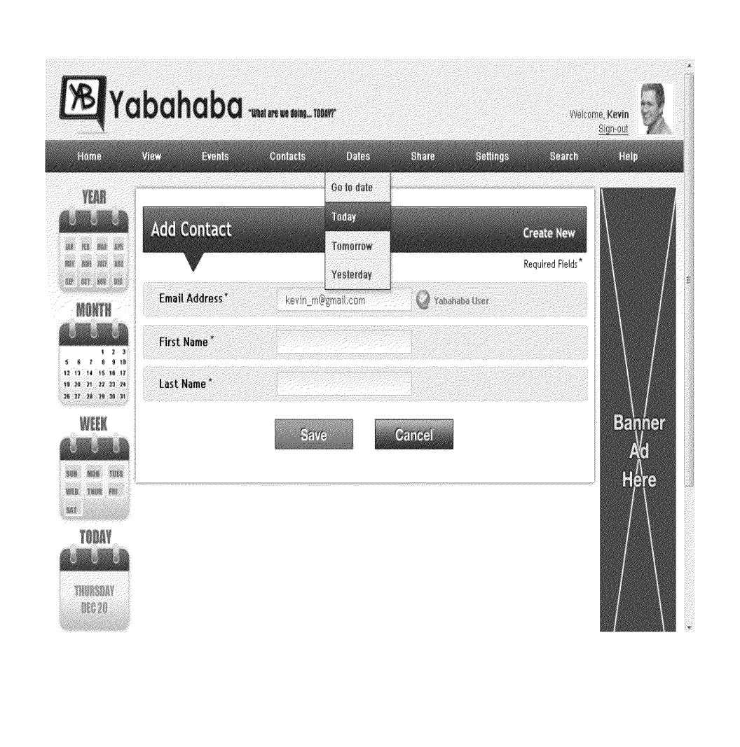

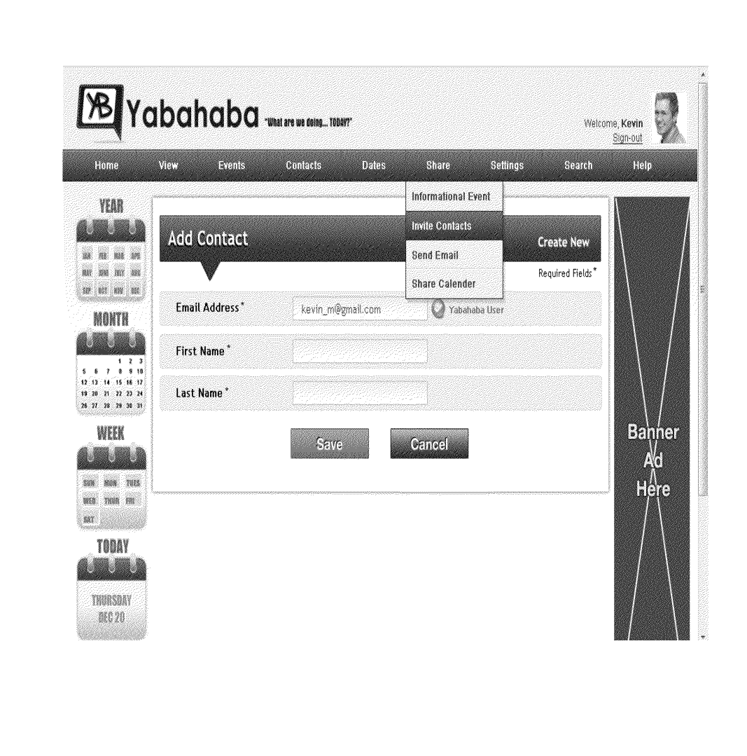

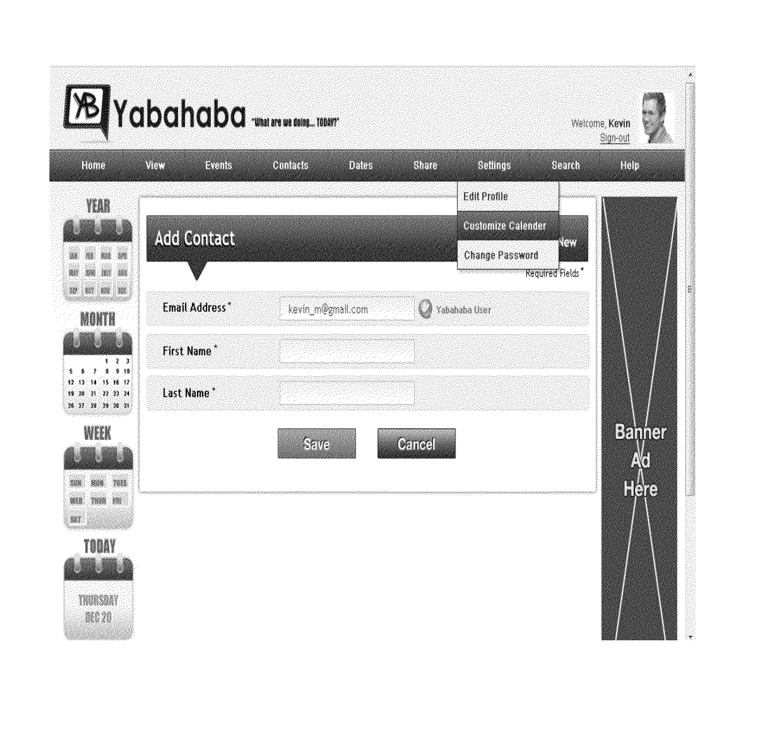

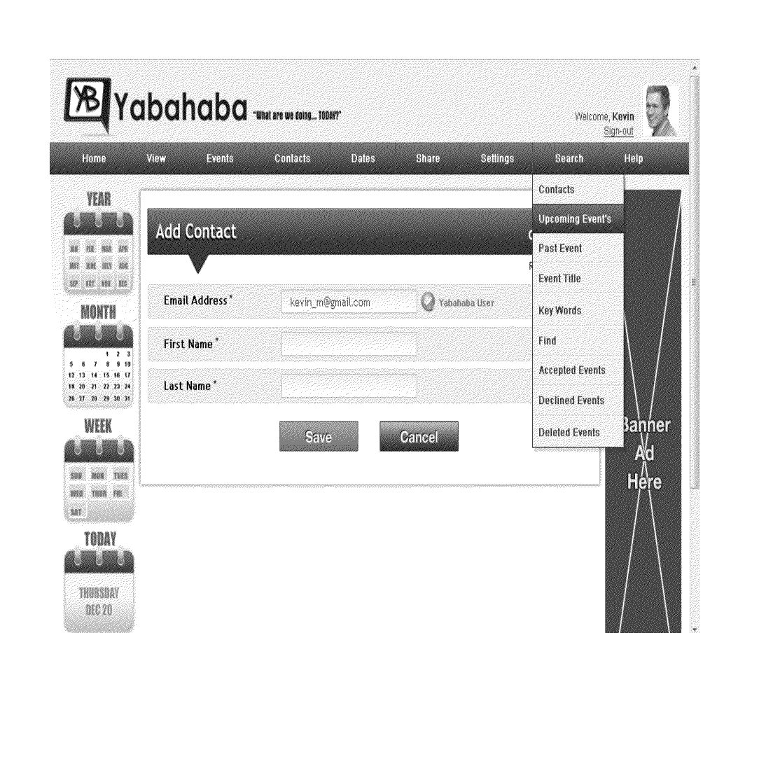

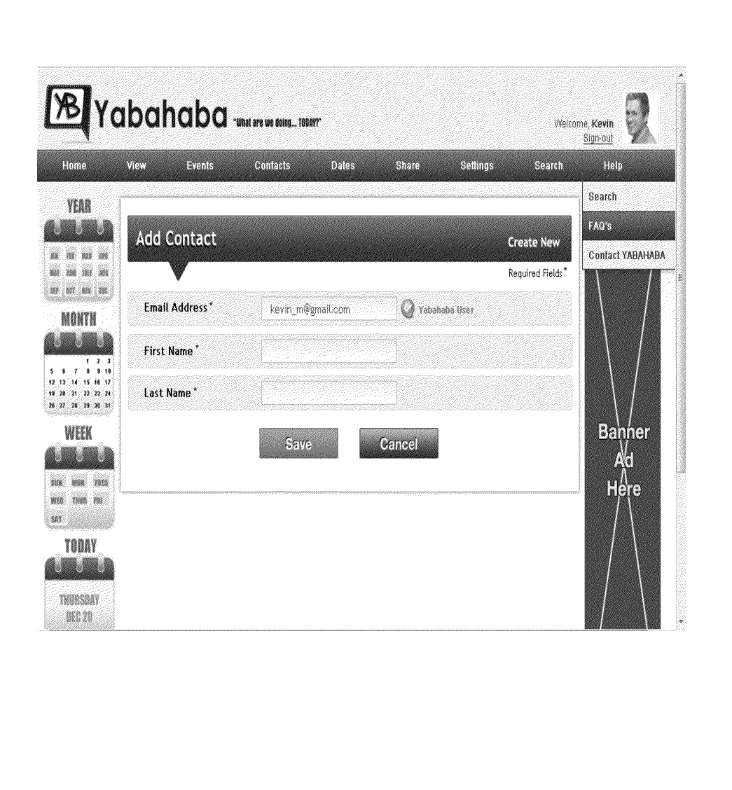

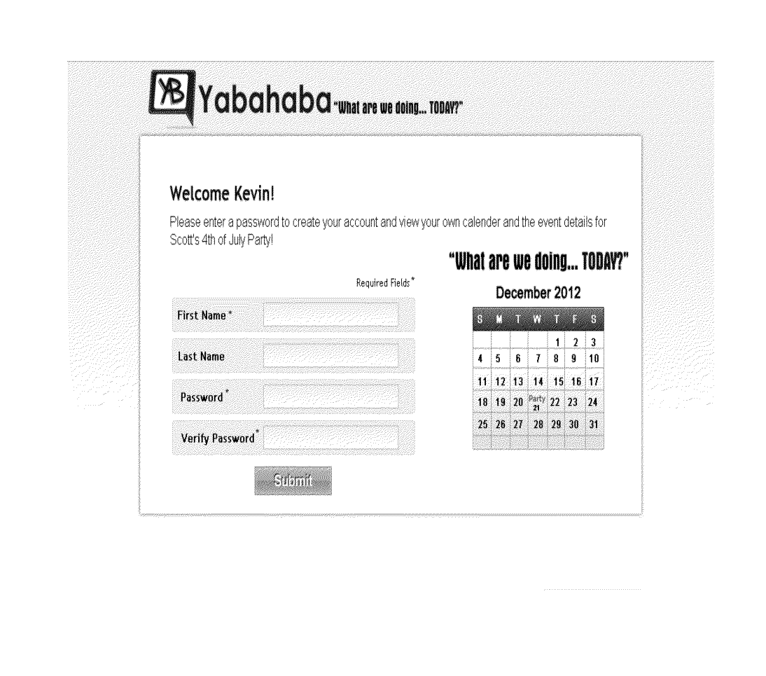

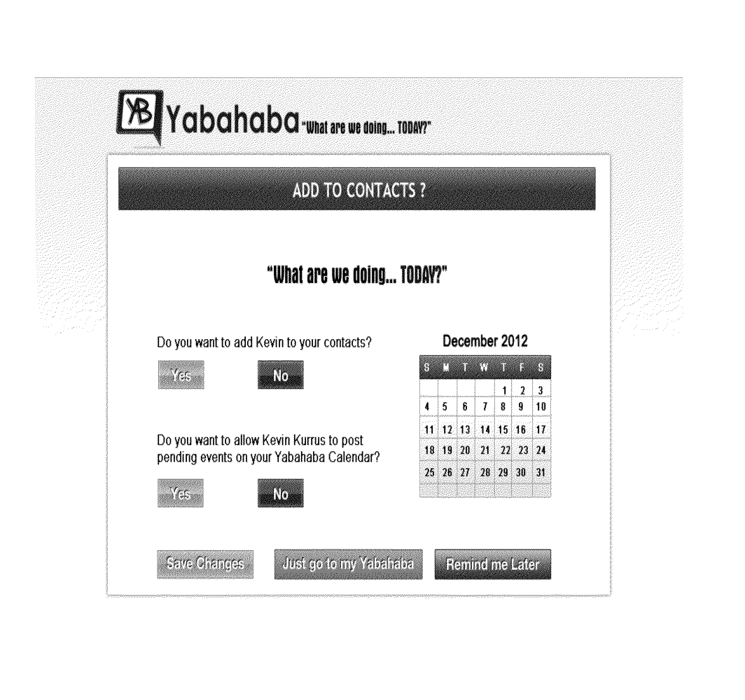

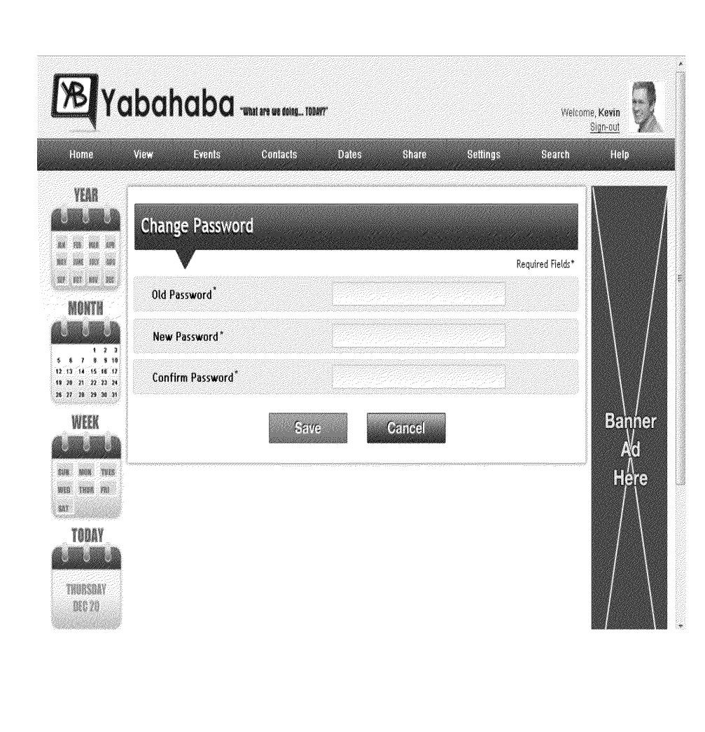

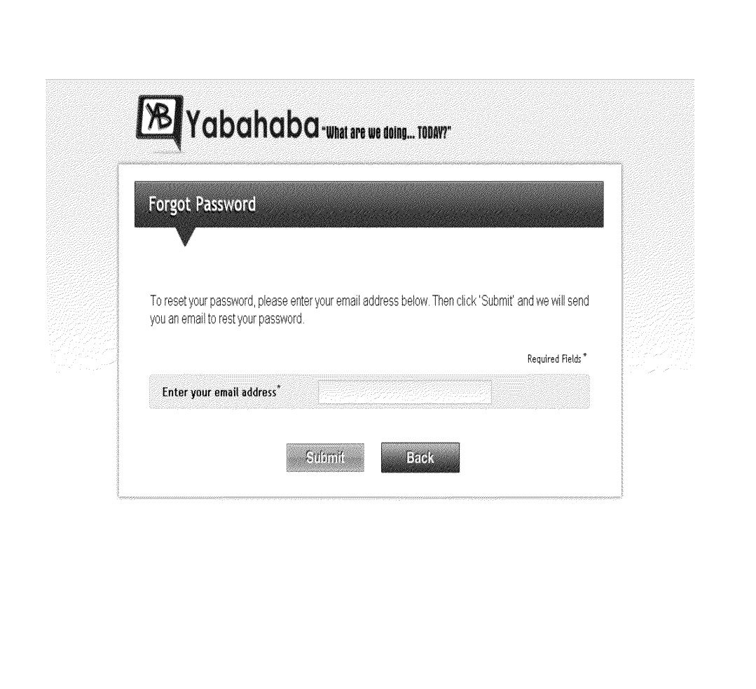

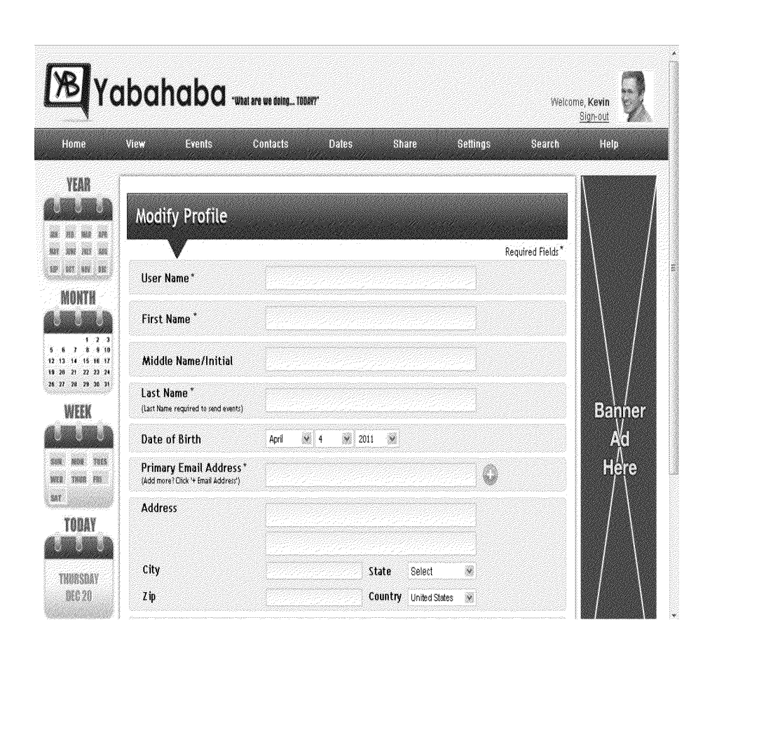

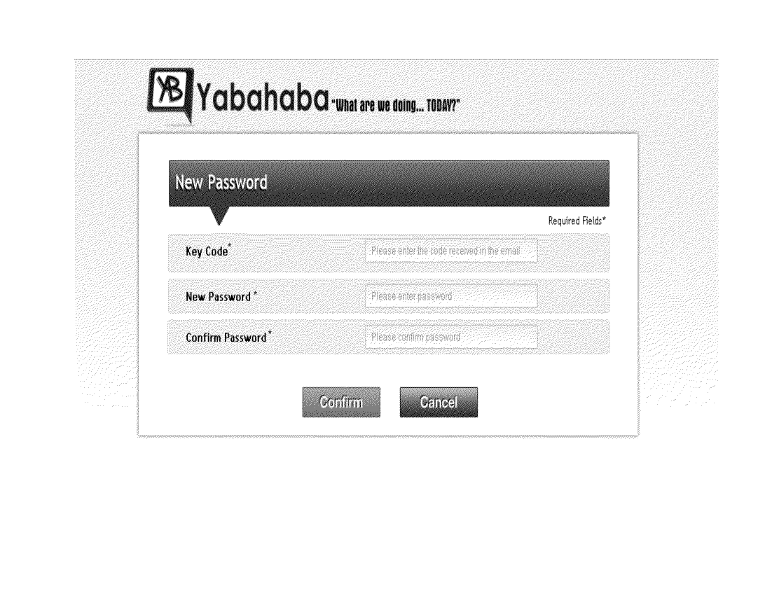

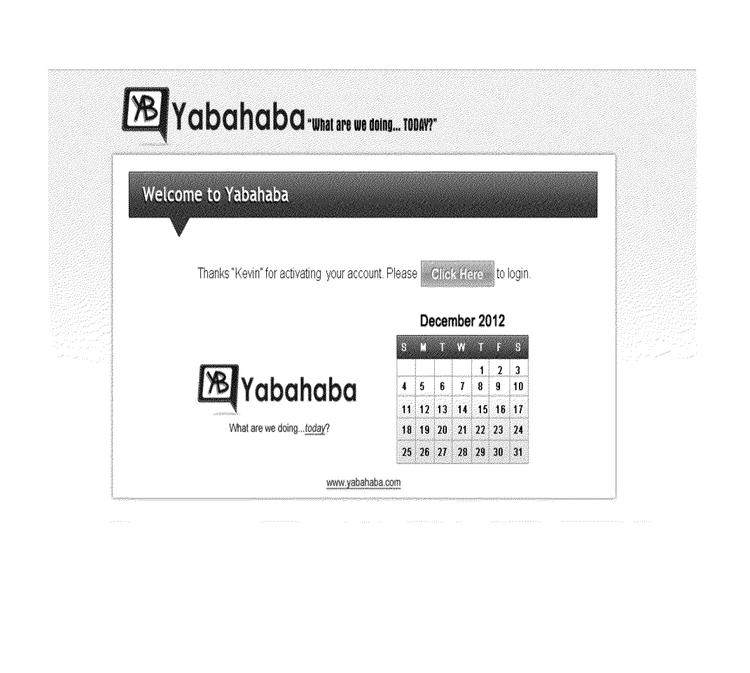

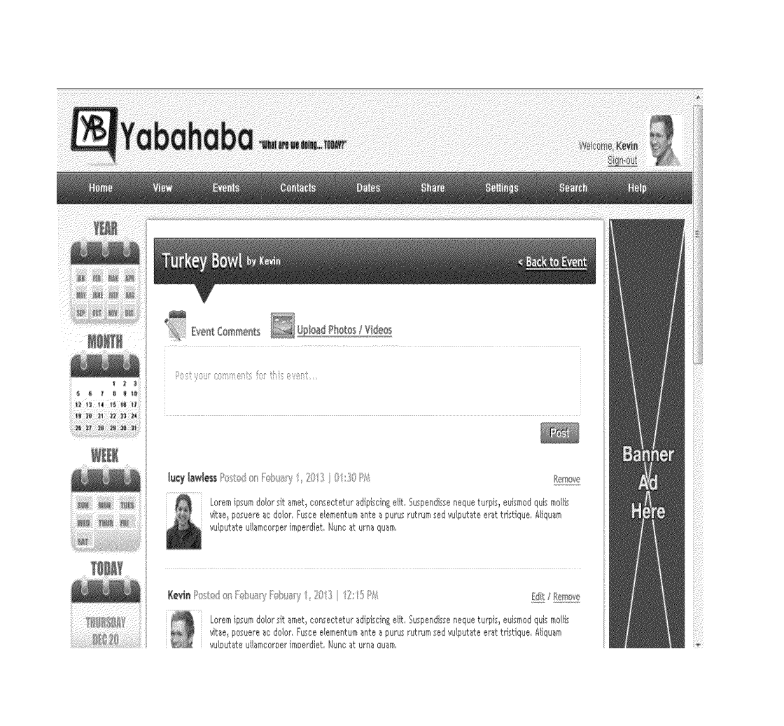

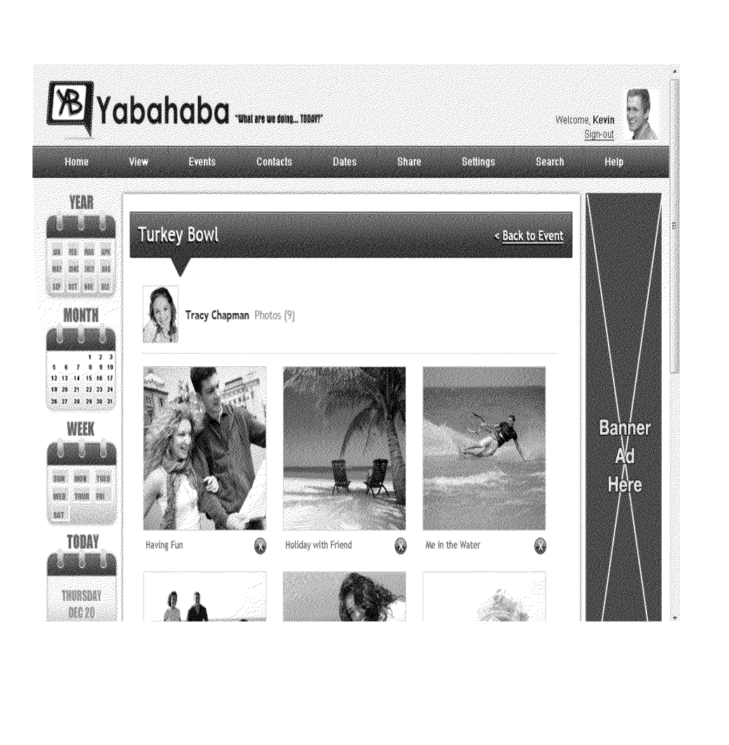

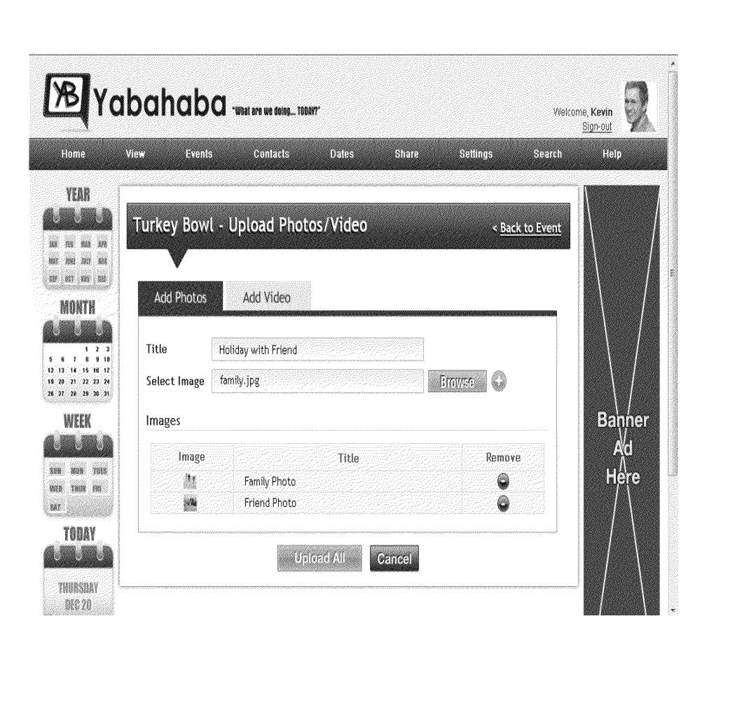

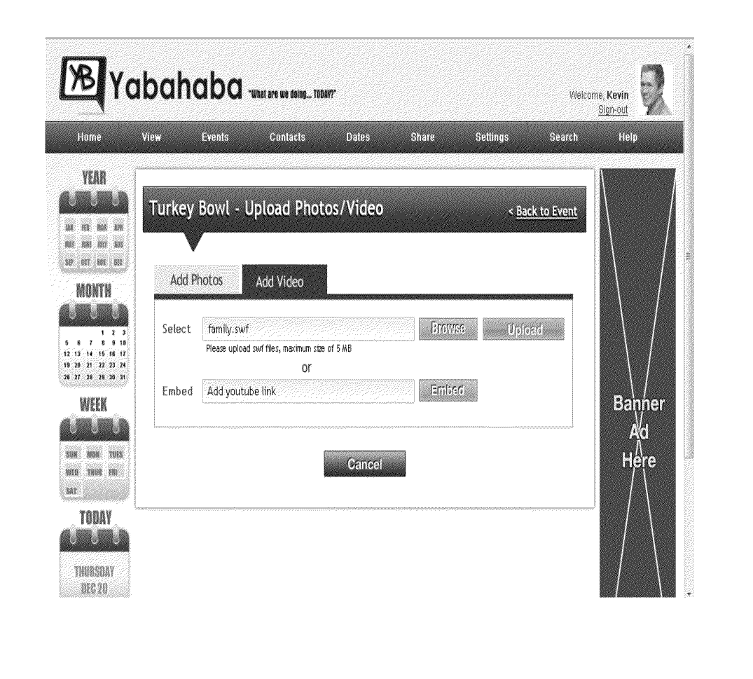

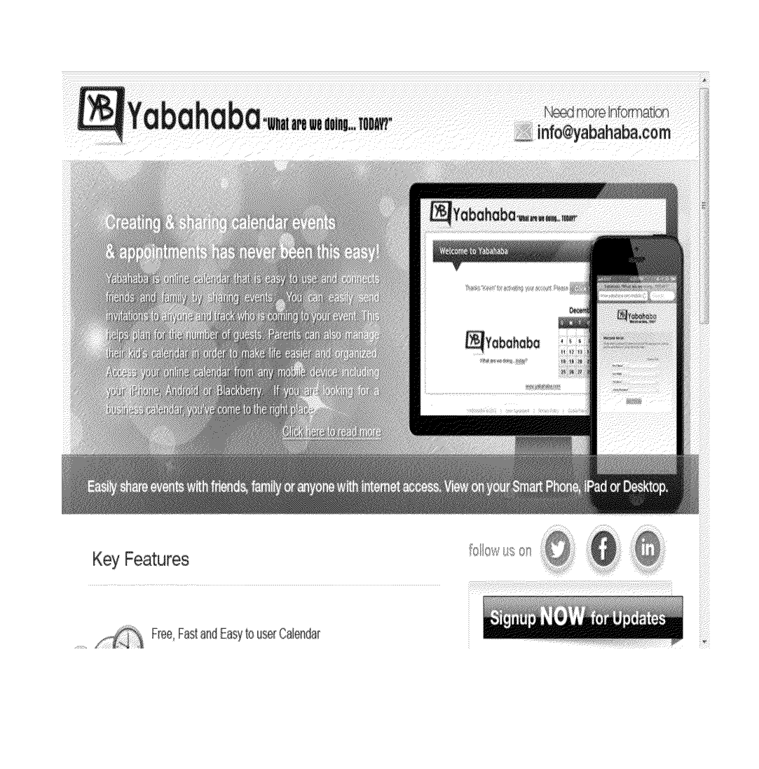

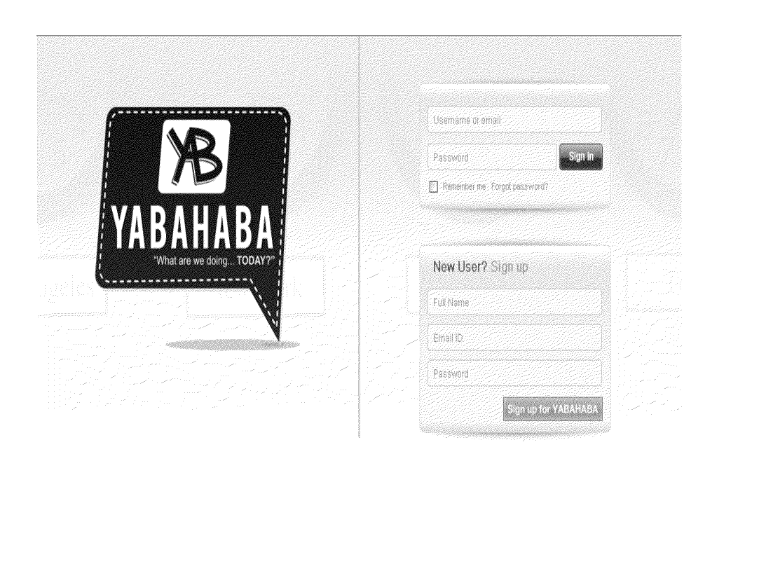

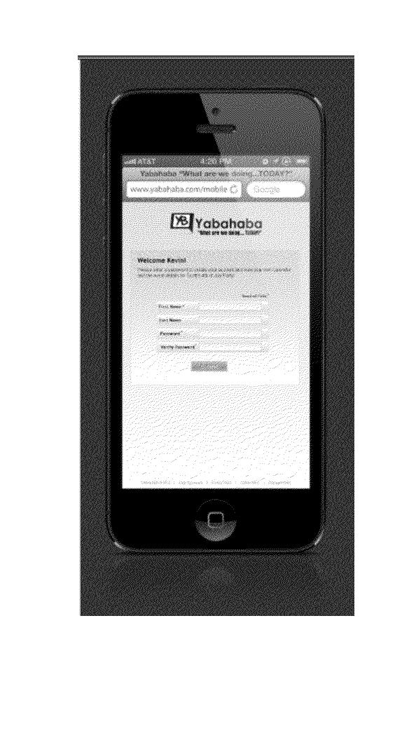

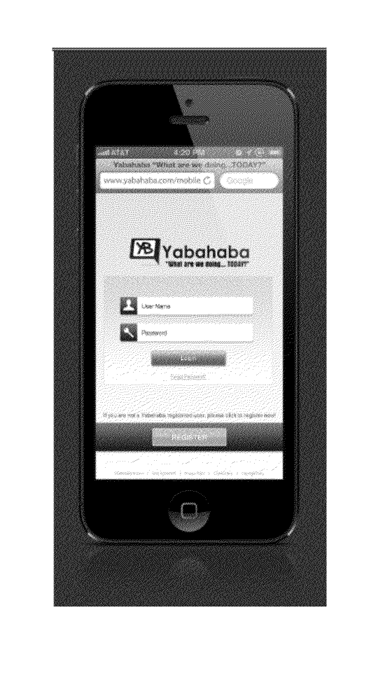

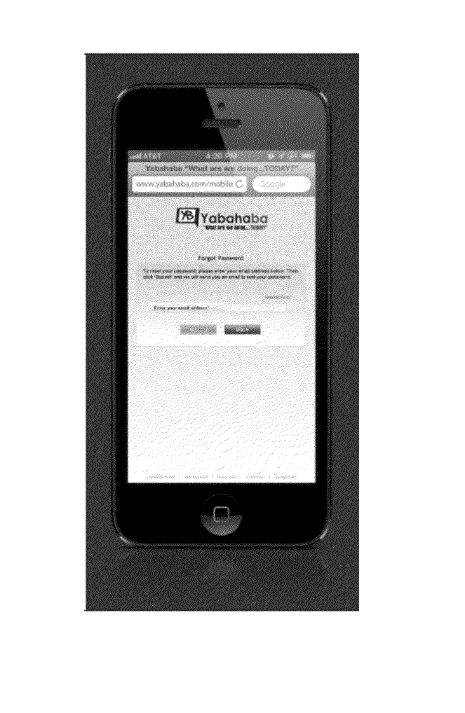

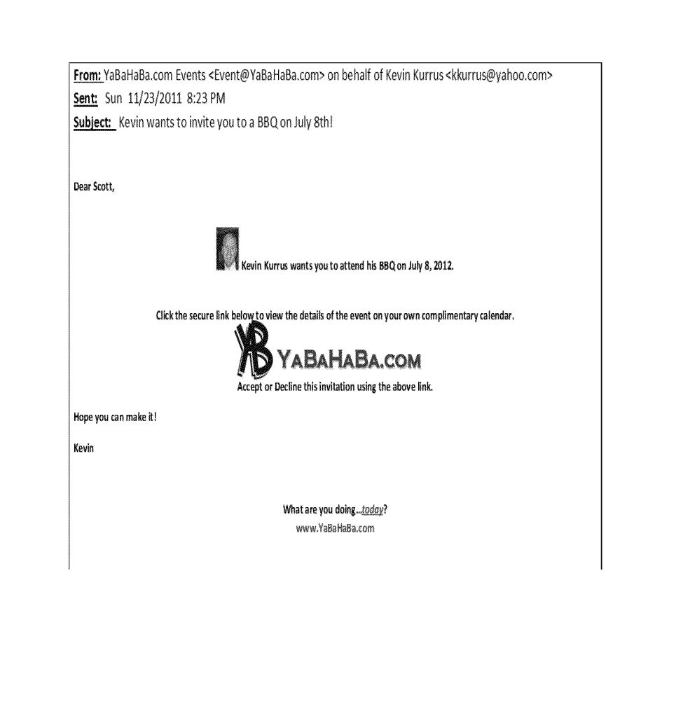

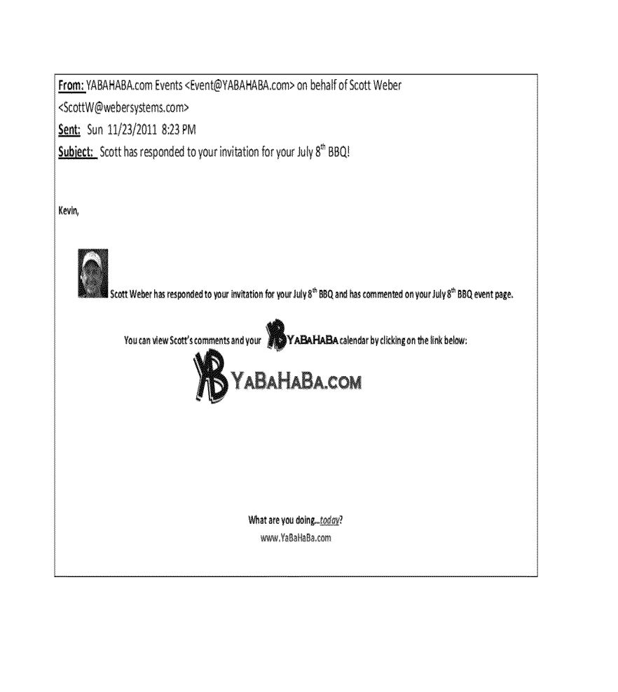

### CROSS REFERENCE TO RELATED APPLICATIONS

This non-provisional patent application is related to U.S. provisional patent application Ser. No. 61/634,192, filing date: Feb. 24, 2012, in that this non-provisional patent application is a follow up for the same invention and contains more comprehensive information in the details and drawings of this invention.

### STATEMENT REGARDING FEDERALLY SPONSORED RESEARCH

N/A

### REFERENCE OF SEQUENCE LISTING

N/A

### BACKGROUND OF INVENTION

1. Field of Invention

This invention relates to an online shared calendar application which effectively and conveniently streamlines scheduling, socializing, and record keeping for users. The feature functions of this online shared calendar application are calendar to calendar event sharing, updating, and communicating. Therefore, this online shared calendar application allows users to more efficiently and effectively coordinate their schedules and plan get-togethers.

People enjoy spending time with their friends and family, look forward to getting together with them, and would benefit from an easy means to organize social events. However, it can be tough for family members and friends to coordinate their schedules and plan get-togethers. Since all calendar functions are completely online, in this online shared calendar application, organizing get-togethers and coordinating events is extremely quick and easy for users.

Many existing calendar applications allow users to only share their entire calendars with other users. Other existing calendar applications generate email messages which are confusing to read and decipher because the formatting of the emails generated by those applications are not always compatible with email providers. Still there are other existing calendar applications that do not easily centralize calendar events online for diversified users. Rather they are compatible with other calendars, such as desktop calendars, and this reduces those calendars' intuitiveness and readability.

This online shared calendar application has several useful features relating to calendaring which have not been implemented together in an existing online shared calendar application. This online shared calendar application is easily accessible and free to all who register. Also, this calendar is strictly online based, and not compatible with desktop calendars or other online calendars. Users of this calendar application will no longer need to go through the process of receiving an email invitation, going to their calendars to see if they are available at that day and time, entering the event information into their calendars, then returning to their email accounts and typing an email to the sender responding with whether or not they can attend the event. This online shared calendar application does this all in one easy to use program. Furthermore, emails generated by this online shared calendar application are easy to read and follow among different email providers.

Therefore, there is a need for an online shared calendar application to seamlessly integrate these various aforementioned features into one online shared calendar application. With the intuitive screen designs and website functionality, this calendar application makes maintaining a calendar and communicating with other users very easy and efficient.

### BRIEF SUMMARY OF INVENTION

The main idea behind this online shared calendar application is that it gives users one program to organize their social events and communicate with each other. Creating an event and choosing individual contacts to invite instantly updates each of their calendars and sends notification emails to the invitees' primary email accounts. These emails serve as notifications and users check their calendars for all of the detailed event information. Users accept or decline invitations to events from their calendars and these responses, in turn, send notification emails to the inviter's primary email account, as well as update the inviter's calendar.

This website allows users to maintain and update their personal, social and business schedules, all on one calendar, free of charge. All information for shared events will be easily accessible for the invitees and they can comment, post pictures, and post videos on the events they were invited to. This site also allows users to upload contacts, search for and add existing users as contacts, and manually enter contacts into their accounts. Users also have the ability to create contact circles from the existing contacts they have in their accounts.

This website is different from other existing calendar applications in a number of ways. This online shared calendar application is completely web-based and free for users, and the calendars generated from this program are only compatible with other calendars generated from the same program. Also, the email messages sent from this online shared calendar application to users' primary email accounts will be compatible and user friendly in terms of intuitiveness, readability, and formatting.

Another notable difference between other existing calendar applications and this online shared calendar application is that users are sharing individual events with other users, and not just sharing their entire calendars. This means that users can plan get-togethers with others simply by sending an event to them through this online shared calendar application. Users will not have to refer to several of their friends or family members' entire calendars to coordinate a get together. What's more, this calendar application facilitates further communication and socialization with other users via comment pages for each event, where users can make comments and upload photos and videos, or other documents and files, on events they either created or were invited to.

This website provides users with a network that helps them organize their schedules, coordinate their plans, and get together with the people they care about. To summarize, this online shared calendar application will streamline the process of scheduling social events, as currently scheduling events may require reading emails, checking personal calendars, entering events into calendars, and then returning to the email account to reply on whether they can attend the event or not.

The benefits and functionality described in this summary are not all-encompassing. Particularly, many additional features and benefits will be obvious to one of ordinary skill in the art in view of the drawings, specification, and claims concerning this invention. Additionally, the language used in this application has been selected purposefully for readability and instructional purposes, and not to delineate or limit the creative subject matter within.

### BRIEF DESCRIPTION OF DRAWINGS

This invention has additional benefits and features which will be more readily apparent from the following detailed description of this invention and the claims, when taken in conjunction with the accompanying drawings.
1/46: Sample ‘yearly calendar’ screen shot which will show the current month first, as well as the next 11 calendar months of a user's calendar. (Information on this page will not always appear exactly as shown here, as it will be tailored towards individual users' preferences. Also, the view of this page is an updated version of the original drawings of this page, which were submitted in the related provisional patent application.)
2/46: Sample ‘monthly calendar’ screen shot which will show the current month with the title of each scheduled event, for that month, displayed. (Information on this page will not always appear exactly as shown here, as it will be tailored towards individual users' preferences. Also, the view of this page is an updated version of the original drawings of this page, which were submitted in the related provisional patent application.)
3/46: Sample ‘monthly calendar with date pop-up’ screen shot will show the current month with the title of each scheduled event, for that month, displayed. When a user hovers over a date box in the monthly view, the date box will pop up showing more information about the events scheduled for that individual date, including the start and end times of each event as well as the weather forecast. (Information on this page will not always appear exactly as shown here, as it will be tailored towards individual users' preferences. Also, the view of this page is an updated version of the original drawings of this page, which were submitted in the related provisional patent application.)
4/46: Sample ‘weekly calendar’ screen shot which will show the current week, Sunday through Saturday, and displays the scheduled events for that week, along with the weather forecast for each day. (Information on this page will not always appear exactly as shown here, as it will be tailored towards individual users' preferences. Also, the view of this page is an updated version of the original drawing of this page which was submitted in the related provisional patent application.)
5/46: Sample ‘daily calendar’ screen shot will show the current day and displays the scheduled events of a user's calendar for that day, including the title of each event, the start and end times of each event, and the weather forecast. (Information on this page will not always appear exactly as shown here, as it will be tailored towards individual users' preferences. Also, the view of this page is an updated version of the original drawing of this page which was submitted in the related provisional patent application.)
6/46: Sample ‘individual event calendar’ screen shot will show all of the comprehensive information on an individual event and allows users to view the guest list and submit comments. (Information on this page will not always appear exactly as shown here, as it will be tailored towards individual users' preferences. Also, the view of this page is an updated version of the original drawing of this page which was submitted in the related provisional patent application.)
7/46: Sample ‘create new event’ screen shot will allow users to create an event by entering the type of event, title of event, dates, times, and location of each event, along with other information. (Information on this page will not always appear exactly as shown here, as it will be tailored towards individual users' preferences.)
8/46: Sample ‘event draft listing’ screen shot will show a list of a user's saved drafts of events and includes the event names, times, and dates of each event draft, along with other information. (Information on this page will not always appear exactly as shown here, as it will be tailored towards individual users' preferences.)
9/46: Sample ‘individual event draft’ screen shot will show an individual event draft, along with the event information which was entered by the user. Users will be able to modify the event information included and delete or send the event from this screen. (Information on this page will not always appear exactly as shown here, as it will be tailored towards individual users' preferences.)
10/46: Sample ‘event invitation’ screen shot will show a received invitation with the included event information. Invitees can accept or decline an event from this page. (Information on this page will not always appear exactly as shown here, as it will be tailored towards individual users' preferences.)
11/46: Sample ‘create new contact’ screen shot which allows users to manually enter a new contact into their accounts and search for other users. (Information on this page will not always appear exactly as shown here, as it will be tailored towards individual users' preferences.)
12/46: Sample ‘contact list’ screen shot which shows a list of a user's contacts and allows users to sort their contacts via a number of different filters. (Information on this page will not always appear exactly as shown here, as it will be tailored towards individual users' preferences.)
13/46: Sample ‘contact circles’ screen shot which shows a list of a user's contact circles and the number of contacts, in parenthesis, next to the name of each contact circle. (Information on this page will not always appear exactly as shown here, as it will be tailored towards individual users' preferences.)
14/46: Sample ‘create new contact circle’ screen shot which allows a user to create a new contact circle by giving it a name and adding members from their contacts. (Information on this page will not always appear exactly as shown here, as it will be tailored towards individual users' preferences.)
15/46: Sample ‘modify existing contact circle’ screen shot which allows a user to modify the name or members in one of their existing contact circles. (Information on this page will not always appear exactly as shown here, as it will be tailored towards individual users' preferences.)
16/46: Sample ‘view members of contact circle’ screen shot which allows a user to view the members of one of their existing contact circles. (Information on this page will not always appear exactly as shown here, as it will be tailored towards individual users' preferences.)
17/46: Sample ‘remove members from contact circle’ screen shot which allows a user to remove members from an existing contact circle. (Information on this page will not always appear exactly as shown here, as it will be tailored towards individual users' preferences.)
18/46: Sample ‘add members to contact circle’ screen shot which allows users to add members when creating a new contact circle. (Information on this page will not always appear exactly as shown here, as it will be tailored towards individual users' preferences.)
19/46: Sample ‘search and add members to contact circle’ screen shot which allows users to search for, and add members to, an existing contact circle. (Information on this page will not always appear exactly as shown here, as it will be tailored towards individual users' preferences.)
20/46: Sample ‘menu screen (Home) toolbar’ screen shot which shows the options users have under the ‘Home’ toolbar function. (Information on this page will not always appear exactly as shown here, as it will be tailored towards individual users' preferences. Also, the view of this page is an updated version of the original drawing of this page which was submitted in the related provisional patent application.)
21/46: Sample ‘menu screen (View) toolbar’ screen shot which shows the options users have under the ‘View’ toolbar function. (Information on this page will not always appear exactly as shown here, as it will be tailored towards individual users' preferences. Also, the view of this page is an updated version of the original drawing of this page which was submitted in the related provisional patent application.)
22/46: Sample ‘menu screen (Events) toolbar’ screen shot which shows the options users have under the ‘Events’ toolbar function. (Information on this page will not always appear exactly as shown here, as it will be tailored towards individual users' preferences. Also, the view of this page is an updated version of the original drawing of this page which was submitted in the related provisional patent application.)
23/46: Sample ‘menu screen (Contacts) toolbar’ screen shot which shows the options users have under the ‘Contacts’ toolbar function. (Information on this page will not always appear exactly as shown here, as it will be tailored towards individual users' preferences. Also, the view of this page is an updated version of the original drawing of this page which was submitted in the related provisional patent application.)
24/46: Sample ‘menu screen (Dates) toolbar’ screen shot which shows the options users have under the ‘Dates’ toolbar function. (Information on this page will not always appear exactly as shown here, as it will be tailored towards individual users' preferences. Also, the view of this page is an updated version of the original drawing of this page which was submitted in the related provisional patent application.)
25/46: Sample ‘menu screen (Share) toolbar’ screen shot which shows the options users have under the ‘Share’ toolbar function. (Information on this page will not always appear exactly as shown here, as it will be tailored towards individual users' preferences. Also, the view of this page is an updated version of the original drawing of this page which was submitted in the related provisional patent application.)
26/46: Sample ‘menu screen (Settings) toolbar’ screen shot which shows the options users have under the ‘Settings’ toolbar function. (Information on this page will not always appear exactly as shown here, as it will be tailored towards individual users' preferences. Also, the view of this page is an updated version of the original drawing of this page which was submitted in the related provisional patent application.)
27/46: Sample ‘menu screen (Search) toolbar’ screen shot which shows the options users have under the ‘Search’ toolbar function. Users can search contacts and events (both past, upcoming, accepted, declined, and deleted) from these menu options. (Information on this page will not always appear exactly as shown here, as it will be tailored towards individual users' preferences. Also, the view of this page is an updated version of the original drawing of this page which was submitted in the related provisional patent application.)
28/46: Sample ‘menu screen (Help) toolbar’ screen shot which shows the options users have under the ‘Help’ toolbar function. (Information on this page will not always appear exactly as shown here, as it will be tailored towards individual users' preferences. Also, the view of this page is an updated version of the original drawing of this page which was submitted in the related provisional patent application.)
29/46: Sample ‘user invitation’ screen shot which shows a screen potential users will be brought to when they click on the link provided in the email invitation they receive from an existing user. (Information on this page will not always appear exactly as shown here, as it will be tailored towards individual users' preferences. Also, the view of this page is an updated version of the original drawings of this page which was submitted in the related provisional patent application.)
30/46: Sample ‘add user to contacts’ screen shot which shows the two questions users will need to answer in order to add another user to their contacts and allow them to post pending events on their calendar. (Information on this page will not always appear exactly as shown here, as it will be tailored towards individual users' preferences.)
31/46: Sample ‘change password’ screen shot which allows a user to change their password by entering their old password and then entering and confirming their new password. (Information on this page will not always appear exactly as shown here, as it will be tailored towards individual users' preferences.)
32/46: Sample ‘forgot password’ screen shot which prompts users to enter their primary email address to reset their password. Once a user enters their password, an email is sent to their primary email account which will prompt the user to create a new password. (Information on this page will not always appear exactly as shown here, as it will be tailored towards individual users' preferences.)
33/46: Sample ‘modify profile’ screen shot which allows a user to modify the information in their existing profile. (Information on this page will not always appear exactly as shown here, as it will be tailored towards individual users' preferences.)
34/46: Sample ‘new password’ screen shot which prompts users to enter a key code, from an email sent to them when they forgot their password, and to enter and confirm their new password. (Information on this page will not always appear exactly as shown here, as it will be tailored towards individual users' preferences.)
35/46: Sample ‘authentication view’ page which shows the page view after users have initially registered for their account. (Information on this page will not always appear exactly as shown here and will be tailored towards individual users' preferences.)
36/46: Sample View/submit comments' screen shot which shows a comment page on an individual event and various comments from the creator of the event and the invitees. (Information on this page will not always appear exactly as shown here, as it will be tailored towards individual users' preferences.)
37/46: Sample ‘view all images’ screen shot which shows the various images posted for an individual event. (Information on this page will not always appear exactly as shown here, as it will be tailored towards individual users' preferences.)
38/46: Sample ‘upload photos’ screen shot which allows users to upload photos associated with an individual event. (Information on this page will not always appear exactly as shown here, as it will be tailored towards individual users' preferences.)
39/46: Sample ‘upload videos’ screen shot which allows users to upload videos associated with an individual event. (Information on this page will not always appear exactly as shown here, as it will be tailored towards individual users' preferences.)
40/46: Sample ‘website landing page’ screen shot which shows the home page of this online shared calendar application. (Information on this page will not always appear exactly as shown here.)
41/46: Sample ‘sign-in’ screen shot which shows the sign-in page for existing users, as well as an option for signing up for new users. (Information on this page may not always appear exactly as shown here, as it may be tailored towards individual users' preferences.)
42/46: Sample ‘user invitation’ screen shot for mobile devices which shows a screen potential users will be brought to when they click on the link provided in the email invitation they receive from an existing user. (Information on this page will not always appear exactly as shown here, as it will be tailored towards individual users' preferences.)
43/46: Sample ‘sign-in’ screen shot for mobile devices which shows the sign-in page for existing users, as well as an option for signing up for new users.
44/46: Sample ‘forgot password’ screen shot for mobile devices which prompts users to enter their primary email address to reset their password. Once a user enters their password, an email is sent to their primary email account which will prompt the user to create a new password.
45/46: Sample ‘event notification email’ screen shot which shows an email that is automatically generated and sent to an invitee when an existing users sends them an event invitation from this online shared calendar application. (Information on this page will not always appear exactly as shown here, as it will be tailored towards individual users' preferences. Also, the view of this page is an updated version of the original drawing of this page which was submitted in the related provisional patent application.)
46/46: Sample ‘event response email’ screen shot which shows an email that is automatically generated and sent to an inviter of an event invitation when an existing invitee responds to an event through their own calendar. (Information on this page will not always appear exactly as shown here, as it will be tailored towards individual users' preferences. Also, the view of this page is an updated version of the original drawing of this page which was submitted in the related provisional patent application.)

### DETAILED DESCRIPTION OF INVENTION

### Basic Functionality of Invention

This is an online shared calendar application and all users have their own personal calendars, which are free, instantly accessible via web browser, and ready to use once they sign up. Users are not generally sharing their entire calendars with others, but rather they are sharing individual events. Users have their own personal online calendars, and the social aspect comes from sharing individual calendar events. When creating an event, users select individuals from their contacts to invite. These selected contacts are notified instantly via emails to their primary email accounts, and their calendars are automatically updated.

Creating, sending, accepting, and declining events automatically updates the events on the invitees' and the inviter's calendars. Email notifications from this online shared calendar application are sent with each event that is created and shared. For the initial email sent when users create and share an event (See drawing #45), the inviter has sent an event invitation to a new potential user. This email notification informs the invitee that they have been invited to a specific event by another person, generally someone they know. (Please note that the content on this page will be updated over time but this screen shot is current as of today.) The invitee will then be prompted to register for their own personal calendar to view the event details and respond.

When a user responds to an event, a notification e-mail is also sent to the inviter's primary email account (See drawing #46). The invitees, who were previously prompted to register for their personal calendars from this online shared calendar application, respond through their calendars and these responses generate automated emails which are sent to the inviter's primary email account. (Please note that the content on this page will be updated over time but this screen shot is current as of today.) These emails provide a link to this online shared calendar application, where the inviter can sign-in and view the invitee's decision and full response, as the inviter's calendar is automatically updated as well when the invitees respond.

If the invitee accepts the invitation, it will remain on his/her personal calendar. If the invitee declines the invitation, it will be removed from his/her personal calendar. The inviter can check his/her calendar to see who responded, who is attending, who is not attending, and the comments on specific events the invitees have made. Friends and family members can share events they wish to share with others, simply by entering the event information and clicking on the names of contacts and/or contact circles they want to invite. Creating, sending, and responding to events is quick and easy for users. The intuitiveness of this calendar application makes it more user-friendly and easier to navigate when compared with other existing calendar applications.

This website is fundamentally a tool for the present and future, but people can also look at events from the past. Events will be time-stamped when they are created, modified, and deleted. By clicking on an event from the past, users can view pictures, read comments, and post new comments, pictures, and videos.

This website is easy to sign up for and instantly creates a calendar for users once they register. Users only need to enter their first name and a password to sign-up. Users' last names are required if they choose to send events to other users. The online shared calendar application is quick, easy to use and access, and very intuitive. This online shared calendar application is a great free resource for users in terms of scheduling and maintaining their personal, social, and business events all on one calendar.

### Calendar Screens Specific Functionality

This online shared calendar application has multiple calendar views including yearly, monthly, weekly, daily, and individual event views. A user can click on the yearly, monthly, weekly, daily, or individual event icons on the left side of the web pages and be brought to the current yearly view, monthly view, weekly view, daily view, or current event view of their calendars. The view of the icons on the left side of the screens range from yearly view (at the top) to the individual event view (at the bottom) and the general order of these icons will be from top to bottom yearly, monthly, weekly, daily, and individual event.

For the yearly calendar screen shot (See drawing #1), users can click on a date box in any month and be brought to that daily calendar view. No information on events will be viewable on the yearly calendar view but the dates which have events scheduled will be distinguishable as the will appear with a bold font. Icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on these arrows allow users to view next 12 months and previous 12 month's view. Users can go as far back or forward as they wish.

The monthly calendar screen shot (See drawing #2) will show the title of each event. Each date cell will list the events scheduled on that day. All events for each date are listed chronologically. Events will be of different types and will be colored according to their type. Users can click on any date box in the monthly view of their calendars and be brought to that date's daily calendar view. Icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on them allow users to view next month and previous month's view. Users can go as far back or forward as they wish.

The monthly calendar view with date pop-up screen shot (See drawing #3) is slightly different from the monthly calendar screen shot in that when a user hovers over a date box in the monthly calendar view, a date box will pop up showing more information about the events scheduled for that individual date. This pop up box will show the title of each event, the start time and end time of each event scheduled for that date, and the weather forecast for that day. All events for each date are listed chronologically. Icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on them allow users to view next month and previous month's view. Users can go as far back or forward as they wish.

Weekly calendar screen shot (See drawing #4) will show the current week, Sunday through Saturday, and the title of each event, the start time of each event, and the weather forecast for each day. Icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on them allow users to view next week and previous week's view. Users can go as far back or forward as they wish.

Daily calendar screen shot (See drawing #5) will show the title of each even scheduled for that day, the start time and end time of each event, and the weather forecast for that day. Users can also choose to add another event to this date from this screen. Icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on them allow users to view next day and previous day's view. Users can go as far back or forward as they wish.

Individual events pages (See drawing #6) contain all comprehensive information on each event including, but not limited to, the title, the start and end times, who else is involved in the event and the location, driving directions, and weather forecast of the event. Users can also view the reason for the event, add/open attachments on the event (if applicable) and view or make comments on the event's individual comment page. Also, icons for the yearly, monthly, weekly, daily and event pages are present as thumbnails on the left side of the screen and users can use these icons to navigate between the different calendar views. Towards the top of the page, on the left and right sides, are ‘previous’ and ‘next’ arrows and clicking on them allow users to view next event and previous event's view. Users can go as far back or forward as they wish.

### Event Functionality

The feature functions of this website are calendar to calendar event emailing, sharing, updating, and communicating. This website streamlines the process of scheduling social events, as currently scheduling events may require reading emails, checking calendars for availability, entering events into calendars, and then going back to email accounts to reply to the inviter.

Individual event pages have all of the relevant information on each event. When users click on an event and go to the event page they will have all pertinent information, including real time weather and driving directions. Each event includes all key details on the event in an easy to read, understand, and digestible format. Users accept or decline event invitations, and are able to comment on each event, through the individual event pages.

If users want to view the specific details for an event, they mouse click on an event from the monthly, weekly, or daily calendar views, and that event's webpage will open. Posting an event, which automatically emails those you wish to invite, will show up on their calendars and the invitees accept or decline the event from their own calendars. Accepting or declining events will automatically update the events on the invitees' calendars and the inviter's calendar. While emails are sent, users need to go to the website to access all information for an event.

Create new event screen shot (See drawing #7) allows users to create an event on their own calendar, and they can select contacts to share this event with if they choose. Users are able to create new events. Once a user creates a new event, that event will appear on the creator's calendar. Create new event pages allow users to enter specific information related to each event. Each event will be associated with an individual comments page and comments can be posted by the inviter and invitees. When a user creates an event and sends it to his contacts, an email is sent to the invitees' primary email accounts. Within these notification emails are references to the inviter and the title and date of the event. There will also be a link in these emails which will take the invitee to the website sign-in page or directly to event if they are already signed-in. New potential users will be prompted to register and create their calendars. Existing users will be prompted to sign-in if they are not already signed in.

Users will be able to choose the category of event, and different categories of events will be color-coded so users can easily identify which events are theirs, and which invites are incoming invitations. Event colors will be different for personal business events, invitations from others, and the user's sent invitations.

Users will type in their own title of each event (up to 20 characters maximum). Users will then select the contacts they which to inform of, or invite to, this event. Users will click on names of those who are invited from contacts. Users will then choose start and end times of the event and will include their phone contact information and the address of the event. Some of this information can be pulled from the user's profile information. Users can also include a message pertaining to their event, choose an RSVP date if they wish, and upload related files to their event.

Creating and sharing events will instantly be sent to the invitees' calendars, with notification emails sent to their email accounts. These notification emails contain some of the event information and users need to go their calendar to view all of the event details and respond to the invitation. Icons for the yearly, monthly, weekly, daily and event pages are present as thumbnails on the left side of the screen and users can use these icons to navigate between the different calendar views.

Event draft listing screen shot (See drawing #8) shows the drafts a user has created but has not sent or saved in his/her calendar. Draft events are listed with the event name, the start and end dates and times, the RSVP date of the event, and the city in which each event is being held. Users can sort their event drafts by any of the aforementioned options and can access the individual event draft pages by clicking on the title of any event draft listed. Icons for the yearly, monthly, weekly, daily and event pages are present as thumbnails on the left side of the screen and users can use these icons to navigate between the different calendar views.

Individual event draft screen shot (See drawing #9) contains all comprehensive information on each event draft including, but not limited to, the title, the start and end times, who else is involved in the event and the location, driving directions, and weather forecast of the event. The creator of the event can also edit the reason for the event, the attachments they added on the event (if applicable) and the guest list they chose. Event drafts are not shared with invitees or updated on calendars until the creator sends the draft to the invitees. Icons for the yearly, monthly, weekly, daily and event pages are present as thumbnails on the left side of the screen and users can use these icons to navigate between the different calendar views.

Event invitation screen shot (See drawing #10) shows an event invitation as viewed by a user that was invited to an event from one of their contacts. Included in this event invitation is the title of the event, the start and end time and dates of the event, and the location of the event along with other relevant information. Users can also view the reason for the event, open attachments on the event (if applicable) and view the guest list (if public) and view or make comments on the event's individual comment page. Users can also accept or decline the event from this page. If the user accepts this event, it will remain on their calendar and if the user declines this event, it will be removed from their calendar. Icons for the yearly, monthly, weekly, daily and event pages are present as thumbnails on the left side of the screen and users can use these icons to navigate between the different calendar views.

View/Submit comments screen shot (See drawing #36) will show all of the comments on an individual event that users, who either created or were invited to the particular event, made on that event. Users can comment on all events they create or were invited to, and an automatic email is generated to each of them every time a comment is made alerting these users that a new comment was posted on that event. Icons for the yearly, monthly, weekly, daily and event pages are present as thumbnails on the left side of the screen and users can use these icons to navigate between the different calendar views.

View all images screen shot (See drawing #37) allows users to view all images uploaded and pertaining to an individual event they either created or were invited to. Icons for the yearly, monthly, weekly, daily and event pages are present as thumbnails on the left side of the screen and users can use these icons to navigate between the different calendar views.

Upload photos screen shot (See drawing #38) shows the webpage where users can upload pictures in relation to an event they either created or were invited to. Users can upload and remove pictures for any event they created from this webpage. Icons for the yearly, monthly, weekly, daily and event pages are present as thumbnails on the left side of the screen and users can use these icons to navigate between the different calendar views.

Upload videos screen shot (See drawing #39) shows the webpage where users can upload videos in relation to an event they either created or were invited to. Users can upload a video from their files or embed the link of an online video's web address. Icons for the yearly, monthly, weekly, daily and event pages are present as thumbnails on the left side of the screen and users can use these icons to navigate between the different calendar views.

### Contacts and Contact Circles Functionality

Users can upload their email contacts from their Yahoo or Google email accounts, they can manually enter contacts, and they can search for other users of this online shared calendar application and add them to their contacts. Then users can modify their contacts and create contact circles (distribution lists) if they wish. Users can easily choose which of their contacts or contacts circles they want to send their events to.

When users invite their contacts to an event, the inviter can select the invitees from their own contacts. Any number of contacts can be invited for the event. A notification email will be triggered to the invited guests at their primary email addresses. The email formats will be different for new users and for existing users. Both formats of emails will contain a secure link which the invitees can click to view the event information. The notification emails will have the inviter's name, the title of the event, and the date of the event, along with a link to this online shared calendar application's website. New users are able to directly register on the website and their calendar, along with the event information, will instantly be ready for their use. Existing users are able to login to their accounts and view the event invitation on his/her calendar.

Users are also able to create and name contact circles and assign individuals from their contacts to one or more contact circles. Users are able to invite members within a contact circle to an event all at once, instead of inviting each contact one by one. For example: if there is a family dinner, selecting the ‘family contact circle’ will send invitation email to all members in the ‘family contact circle’, as well as update their calendars.

Create new contact screen shot (See drawing #11) allows a user to manually enter the information of someone they wish to be a contact in their calendar. In the contact diary of a user, only the email, first name and last name will be stored. There will be two scenarios here. In scenario 1, a user is trying to add a new contact which is not a current user of this online shared calendar application. The user needs to know the email, first name and last name of this person they wish to add as a contact. When an event invitation is sent to this user, that user will sign in and update his/her profile. In scenario 2, a user is trying to add a new contact, who is already a user of this online shared calendar application. In this scenario, entering that person's email address will prompt a message to appear that this person is currently a user. His or her first name and last name will appear in the boxes and clicking on save will add that user in my contact list. Users can add any contact in their contact list and send them event invitations. Icons for the yearly, monthly, weekly, daily and event pages are present as thumbnails on the left side of the screen and users can use these icons to navigate between the different calendar views.

Contact list screen shot (See drawing #12) which shows the first number of contacts in a user's account. Users can view their contacts and sort them by date modified, first name, or last name. Users can also search for individual contacts in their account, import contacts, and choose the number of contacts per page they wish to display. Icons for the yearly, monthly, weekly, daily and event pages are present as thumbnails on the left side of the screen and users can use these icons to navigate between the different calendar views.

Contact circles screen shot (See drawing #13) which shows a list of the existing contact circles in a user's account. The number of members in each contact circle is located to the right of each title of the contact circles in parenthesis. Users can click on a contact circle to be brought to that contact circle page and view the members of their contacts in that contact circle. Icons for the yearly, monthly, weekly, daily and event pages are present as thumbnails on the left side of the screen and users can use these icons to navigate between the different calendar views.

Create new contact circle screen shot (See drawing #14) allows users to create new contact circles by entering a name for the contact circle. Users can select contacts to enter to a new contact circle through this page as well. Icons for the yearly, monthly, weekly, daily and event pages are present as thumbnails on the left side of the screen and users can use these icons to navigate between the different calendar views.

Modify existing contact circle screen shot (See drawing #15) allows users to edit the name of an existing contact circle and update the members in a particular contact circle. Icons for the yearly, monthly, weekly, daily and event pages are present as thumbnails on the left side of the screen and users can use these icons to navigate between the different calendar views.

View members of contact circle screen shot (See drawing #16) shows the members of an existing contact circle in a user's account. Users can add members or remove members from a particular contact circle from this page. Icons for the yearly, monthly, weekly, daily and event pages are present as thumbnails on the left side of the screen and users can use these icons to navigate between the different calendar views.

Remove members from contact circle screen shot (See drawing #17) allows users to remove current members in a contact circle from their account. Users click the check boxes of the individual members of an existing contact circle and then click the ‘remove’ button to update their contact circle.

Icons for the yearly, monthly, weekly, daily and event pages are present as thumbnails on the left side of the screen and users can use these icons to navigate between the different calendar views.

Add members to contact circle screen shot (See drawing #18) allows users to add members from their contacts to an existing contact circle. Users click the check boxes of the individual members of their contacts they wish to add to this particular contact circle and then click the ‘add to contact circle’ button to update their contact circle. Icons for the yearly, monthly, weekly, daily and event pages are present as thumbnails on the left side of the screen and users can use these icons to navigate between the different calendar views.

Search and add members to contact circle screen shot (See drawing #19) shows an existing contact circle and users have the ability to search for other existing users and add them to this particular contact circle. Icons for the yearly, monthly, weekly, daily and event pages are present as thumbnails on the left side of the screen and users can use these icons to navigate between the different calendar views.

### Toolbar Functionality

Menu screen (Home) toolbar screen shot (See drawing #20) where users can view their profile, create a new event, view their contacts, go to a particular date, utilize the search function, print, or sign out from these menu options. Icons for the yearly, monthly, weekly, daily and event pages are present as thumbnails on the left side of the screen and users can use these icons to navigate between the different calendar views.

Menu screen (View) toolbar screen shot (See drawing #21) where users can view their yearly, monthly, weekly, daily, or individual events calendar views and they can view their contacts from these menu options. Icons for the yearly, monthly, weekly, daily and event pages are present as thumbnails on the left side of the screen and users can use these icons to navigate between the different calendar views.

Menu screen (Events) toolbar screen shot (See drawing #22) where users can create new events, view today's, tomorrow's, and yesterday's events, as well as this week's and this month's events. Also, users can view an event history, pending events, and search and view drafts from these menu options. Icons for the yearly, monthly, weekly, daily and event pages are present as thumbnails on the left side of the screen and users can use these icons to navigate between the different calendar views.

Menu screen (Contacts) toolbar screen shot (See drawing #23) where users can view and email contacts and create new contacts and contact circles from these menu options. Icons for the yearly, monthly, weekly, daily and event pages are present as thumbnails on the left side of the screen and users can use these icons to navigate between the different calendar views.

Menu screen (Dates) toolbar screen shot (See drawing #24) where users can view go to a particular date, as well as view today, tomorrow's, or yesterday's events from these menu options. Icons for the yearly, monthly, weekly, daily and event pages are present as thumbnails on the left side of the screen and users can use these icons to navigate between the different calendar views.

Menu screen (Share) toolbar screen shot (See drawing #25) where users can share an informational event, invite contacts to an event, send an email, or share their entire calendar with another user from these menu options. Icons for the yearly, monthly, weekly, daily and event pages are present as thumbnails on the left side of the screen and users can use these icons to navigate between the different calendar views.

Menu screen (Settings) toolbar screen shot (See drawing #26) where users can edit their profile, customize their calendar, or change their password from these menu options. Icons for the yearly, monthly, weekly, daily and event pages are present as thumbnails on the left side of the screen and users can use these icons to navigate between the different calendar views.

Menu screen (Search) toolbar screen shot (See drawing #27) where users can search contacts and events (past, upcoming, accepted, declined, and deleted) from these menu options. Icons for the yearly, monthly, weekly, daily and event pages are present as thumbnails on the left side of the screen and users can use these icons to navigate between the different calendar views.

Menu screen (Help) toolbar screen shot (See drawing #28) where users can use the search function, view frequently asked questions, or contact the company, Yabahaba, from these menu options. Icons for the yearly, monthly, weekly, daily and event pages are present as thumbnails on the left side of the screen and users can use these icons to navigate between the different calendar views.

### Profile and Password Functionality

Modify profile screen shot (See drawing #33) which allows users to manage and modify their existing profile information in their account for this online shared calendar application. Icons for the yearly, monthly, weekly, daily and event pages are present as thumbnails on the left side of the screen and users can use these icons to navigate between the different calendar views.

Change password screen shot (See drawing #31) which shows the screen where users can change their existing password by entering their old password, and then entering and confirming their new password. Icons for the yearly, monthly, weekly, daily and event pages are present as thumbnails on the left side of the screen and users can use these icons to navigate between the different calendar views.

Forgot password screen shot (See drawing #32) which prompts users who forgot their passwords to enter their primary email address, which is registered with their account of this online shared calendar application. Users receive an email to their primary email account which contains a key code and a link where users can go to reset their password.

New password screen shot (See drawing #34) which shows the page users are brought to after they have forgotten the password to their calendar in this online shared calendar application. The users who forget their passwords receive an email to their primary email accounts and those emails contain a key code and a link to this page. Users who forgot their password to this online shared calendar application are prompted to enter the key code included in the email message they received and they must enter and confirm their new password to reset their password.

### Log-In and Administration Functionality

User invitation screen shot (See drawing #29) shows the first screen new potential users are brought to when they first receive an invitation for an event from an existing user of this online shared calendar application. New potential users need only to include their first name and password, and then confirm their password, to access their free calendar from this online shared calendar application. New users will see the event they were invited to already posted on their calendars. Also, new users can add additional personal information whenever they wish, but they must add their last names to their profiles if they wish to create an event and send it to others.

Add user to contacts screen shot (See drawing #30) shows the prompt this online shared calendar application will present to users, asking users if they want to add another user as a contact and if they want to allow this other user to post pending events on their calendar. All users of this online shared calendar application cannot just post a pending event on another user's calendar. Rather, users have to grant permission for other users to post pending events on their calendars and this screen shot shows how users can grant these permissions to others.

Authentication screen shot (See drawing #35) which shows the screen that immediately follows once a new user has registered for their calendar. Users are prompted to sign-in to access and use their personal calendars from this online shared calendar application.

Website landing page view (See drawing #40) shows the home page view of this online shared calendar application. This landing page displays important information on the key features of this online shared calendar application and will capture the attention of the visitors who visit this page. (Please note that the content on this page will be updated over time but this screen shot is current as of today.)

Sign-in page view (See drawing #41) which shows the standard log-in page for users to log-in and access their calendar from this online shared calendar application. New potential users who arrive on this page can also go through this page to register for their own personal calendar from this online shared calendar application.

For administration, validation methods will be applied to check for any error prone or malicious inputs from users. The access to all sections of application will be managed through security. This online shared calendar application will provide an interface, through which members will be able to connect to other members. A system administrator will be able to “freeze (stop)” any members account. In those cases, the user will not be able to login into his/her account until the issue is resolved to the satisfaction of Yabahaba security. Security options allow users to log out of the system.

The administration end will be used by a system administrator of this online shared calendar application. A system administrator is able to log into the site using an administration email ID and password. A system administrator is able to manage users from this section. All the users registered on this online shared calendar application will be listed in a grid. Clicking on user email will show the profile detail of user. A system administrator is not able to change profile information of a user. However, he/she is able to activate, deactivate, or delete a user and review the content on their account.

This module also allows the system administrator to manage comments/videos/images posted by users on an event. A system administrator is able to delete any comment, video or image posted on en event. The system administrator is able to specify holiday templates for a year. A default template will be set by the system administrator, however users are able to change the template as per his/her requirement.

Users can give rights to another user to view and view/edit/delete their calendar and this system requires a Login ID and password to access. Validation methods will be applied to check for any error prone or malicious inputs from the user.

### Mobile Functionality

The mobile compatible version of this online shared calendar application includes register and login functions. Other functions included in this mobile compatible version of this online shared calendar application include the ability for users to move to next and previous daily calendar views, view event details, accept and decline events, create new events, send invites, view contacts, forgot and reset password, a ‘go to date’ screen, the monthly calendar view (without details and just an image to let the user know they have something scheduled for that day), and the weekly calendar view (with limited information).

The ‘user invitation’ screen shot for mobile devices (See drawing #42) shows a screen potential users will be brought to when they are on a mobile compatible device and they click on the link provided in the email invitation they received from an existing user.

The ‘sign-in’ screen shot for mobile devices (See drawing #43) shows the sign-in page for existing users, as well as an option for signing up for new users, when they are on a mobile device.

The ‘forgot password’ screen shot for mobile devices (See drawing #46) prompts users to enter their primary email address to reset their password when they are on a mobile device. Once a user enters their password, an email is sent to their primary email account, and this email prompts them to create a new password.

### Process of Making Invention

The process of making this online shared calendar application began with the development and delivery of SRS (Software Requirements Specification) document followed by a series of five (5) milestones.

The first milestone included the completion of logo and website design, the production of HTML pages, and the start of the design of mobile compatible screens.

The second milestone included the completion of the first set of modules, which included the ‘User module’, the ‘Administration module’, and the ‘Date module’. The ‘User module’ included the creation of the ‘registering as a new user’, ‘user log-in’, ‘forgot password’, ‘change password’, ‘manage profile’, and ‘dashboard/toolbar’ screens. The creation of the mobile compatible website designs were also part of the ‘User module’. The ‘Administration module’ included the completion of the ‘login’, ‘forgot password’, and ‘change password’ functionality. The ‘Date module’ included the completion of the ‘date’ screens, the ‘listing’ and ‘modifying’ of events screens and the ‘search’ screens.

The third milestone included the completion of second set of modules, which included the ‘Events module’ and the ‘Contacts module’. The ‘Events module’ included managing events functionality, including listing, modifying, and deleting events, and navigating the calendar views, including the yearly, monthly, monthly with pop-up date box, weekly, daily, and individual event calendar views. The ‘Contacts module’ included the completion of the contacts functionality which include the creation, listing, modifying, deleting, importing, searching, exporting, and managing of contacts, as well as the creation and managing of contacts circles.

The fourth milestone included the completion of the third set of modules, which included the ‘Administration module’ and the ‘Events module’. The ‘Administration module’ refers to the inventors' ability to oversee users, the CMS (Content Management System), and the comments, images, and videos users post. The ‘Events module’ refers to the functionality of sending invitations, registering new users, communication emails from this online shared calendar application, and all aspects of events including event comments, event history, pending events, past events, accepted events, declined events, and search events.

The fifth and final milestone included the completion of the mobile compatible website for this online shared calendar application. The mobile compatible website includes the login and register functions. Other functions included in this milestone for the mobile compatible version of this online shared calendar application include the ability for users to move to next and previous daily calendar views, view event details, accept and decline events, create new events, send invites, view contacts, forgot and reset password, a ‘go to date’ screen, the monthly view (without details and just an image to let the user know they have something scheduled for that day), and the weekly view (with limited information).

1. A feature function of this online shared calendar application, users are sharing individual events, and related event information, from their calendars with other users' calendars.

2. The computer implemented method of claim 1, wherein creating and sharing events with others will automatically update the sender's and the invitees' calendars.

3. The computer implemented method of claim 1, where users are notified of events from other users via automated emails, which are sent to the invitees' primary email accounts once an event is created and sent to them.

4. The computer implemented method of claim 1, wherein all users will have to indicate their approval to have other users post pending events on their calendars.

5. The computer implemented method of claim 1, wherein users can view and add comments, pictures, and videos on event pages they either created or were invited to.

6. Creating and sharing events, and responding to and commenting on events, generates automatic notification emails to the inviter's and invitees' primary email accounts, which are registered with this online shared calendar application.

7. The computer implemented method of claim 6, wherein automated emails generated by this online shared calendar application are compatible with users' primary email providers to ensure easy readability and communication of event information.

8. The computer implemented method of claim 6, wherein event email notifications sent from this online shared calendar application will contain the name of the inviter and the title of the event being shared.

9. The computer implemented method of claim 6, wherein invitees' responses to events, and all subsequent communication on events, will generate and send notification emails to the sender's and invitees' primary email accounts.

10. The computer implemented method of claim 6, wherein users can create different types of events and each event type is color coded to make identification of types of events easy for users.

11. This online shared calendar application is completely web based and any user who has internet access can sign up for, and immediately use, their personal calendar from a desktop computer, laptop, or smart phone.

12. The computer implemented method of claim 11, wherein this online shared calendar application is not compatible with other online or desktop calendars, which reduces the confusion that results from other calendar applications merging with other online and/or desktop calendars.

13. The computer implemented method of claim 11, wherein all new potential users are initially brought to an online registration page where they can sign up for their free calendar with only their first names, primary email addresses, and a password of their choosing.

14. The computer implemented method of claim 11, wherein users of this online shared calendar application can maintain, manage, and modify their own profile information online, which includes a profile picture.

15. The computer implemented method of claim 11, wherein users can upload contacts from select email providers online, search for and add existing users of this online shared calendar application to their contacts, and can manually enter individual contacts and their information into their contacts.

16. The computer implemented method of claim 11, wherein users can create contact circles, which are essentially distribution lists, online from the contacts in their account with this online shared calendar application.

17. The computer implemented method of claim 11, wherein this online shared calendar application has five (5) primary calendar views which are yearly, monthly, weekly, daily, and individual event calendar views, and the icons on the left side of web pages allows users to navigate between these calendar views online.
